(19) United States
(12) Patent Application Publication
(10) Pub. No.: US 2026/0289331 A1
(43) Pub. Date: Sep. 24, 2026

(54) SYSTEM

(71) Applicant: SoftBank Group Corp., Tokyo (JP)

(72) Inventor: Takayuki MIURA, Tokyo (JP)

(73) Assignee: SoftBank Group Corp., Tokyo (JP)

(21) Appl. No.: 19/567,393

(22) Filed: Mar. 16, 2026

(30) Foreign Application Priority Data
Mar. 19, 2025 (JP) 2025-045073

(51) Int. Cl. G06N 5/01; G06F 40/205; G06F 40/40; G06N 3/0475

(52) U.S. Cl. CPC G06N 5/01; G06F 40/205; G06F 40/40; G06N 3/0475

(57) ABSTRACT

A system includes a processor that is configured to provide a user interface through which a user selects a sport and inputs past competition history, match results, and characteristics desired of an opponent, store, in a database, information input through the user interface, and generate, based on the stored information, a prompt for instructing a search for an opponent, and input the prompt to a generative AI model to search for the opponent.

### CROSS-REFERENCE TO RELATED APPLICATION

This application is based on and claims priority under 35 USC 119 from Japanese Patent Application No. 2025-045073 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional opponent matching systems in the field of sports and competitive activities typically rely on fixed rule-based filters or simple matching algorithms that consider only limited user attributes such as skill level or preferred time slots. As a result, such systems often fail to capture nuanced user requirements, including detailed competition history, specific match results, and rich, free-form descriptions of desired opponent characteristics. Moreover, existing systems generally do not effectively utilize large-scale generative AI models capable of interpreting complex natural-language conditions and dynamically forming search instructions. Consequently, it is difficult for users to easily obtain highly suitable opponents who match both objective data, such as past performance, and subjective preferences, such as play style or personality. There is therefore a need for a system which can flexibly acquire detailed user input, store it in a structured manner, and generate an appropriate prompt for a generative AI model in order to perform an opponent search that better reflects the user's actual needs.

### SUMMARY

In order to solve the above-mentioned problem, the present invention provides a system comprising a processor, wherein the processor is configured to provide a user interface through which a user selects a sport and inputs past competition history, match results, and characteristics desired of an opponent, and to store, in a database, information input through the user interface. The processor is further configured to generate, based on the stored information, a prompt for instructing a search for an opponent, and to input the prompt to a generative AI model to search for the opponent. In some embodiments, the processor is configured to provide a user interface through which the user, when inputting a schedule in which the user is available to play, further inputs venue information, and to store the venue information in the database, thereby allowing the opponent search to take account of temporal and spatial constraints. In other embodiments, the processor is configured to provide a user interface through which the user inputs the characteristics desired of an opponent, and to generate, based on the characteristics, the prompt for instructing the search for the opponent, thereby enabling the generative AI model to interpret detailed user preferences expressed in natural language and to perform an opponent search that is more finely tuned to the user's intentions.

The term “system” refers to a combination of hardware and software components, including at least one processor and associated memory and interfaces, that collectively perform the functions described in the claims.

The term “processor” refers to one or more hardware processing units, such as a CPU, GPU, or dedicated logic circuitry, capable of executing instructions to carry out the operations described in the claims.

The term “user interface” refers to any hardware and software mechanism, including graphical user interfaces, web pages, mobile application screens, or command-line interfaces, that allows a user to input information to, and receive information from, the system.

The term “user” refers to a human operator who interacts with the system through the user interface to input information such as sport selection, competition history, desired opponent characteristics, schedules, and venue information.

The term “sport” refers to any physical or competitive activity, including but not limited to tennis, soccer, basketball, badminton, or similar disciplines, for which a user may seek an opponent through the system.

The term “past competition history” refers to information about previous matches or games played by the user, including but not limited to dates, opponents, scores, results, and optional contextual details.

The term “match results” refers to outcome-related data of a competition, including at least an indication of win, loss, or draw and optionally including numerical scores, sets, or points.

The term “characteristics desired of an opponent” refers to one or more conditions or attributes specified by the user for a preferred opponent, including but not limited to skill level, play style, frequency of play, or other qualities, which may be expressed in structured form or as free-form natural language.

The term “database” refers to any structured data storage system, including relational, document-oriented, key-value, or other types of data stores, in which the system persists user-related information for later retrieval and processing.

The term “schedule” refers to temporal availability information input by the user, including at least a date and time period during which the user is able or willing to participate in a competition.

The term “venue information” refers to location-related data associated with a competition or availability time, including but not limited to the name of a facility, address, court number, or geographic coordinates.

The term “prompt” refers to a data structure or piece of content, typically expressed in natural language or semi-structured form, generated by the processor based on stored information, and designed to instruct a generative AI model to perform an opponent search.

The term “generative AI model” refers to a machine learning model, such as a large language model or similar generative model, that is capable of receiving a prompt and producing output, including inferred search conditions or candidate opponent suggestions, based on learned patterns.

The term “opponent” refers to another user or player identified or searched for by the system as a potential competitor to participate in a sport or competition with the user.

The term “search for an opponent” refers to a process in which the system, alone or in cooperation with a generative AI model, identifies one or more candidate opponents that satisfy conditions derived from the user's stored information, including competition history, desired characteristics, schedule, and venue information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

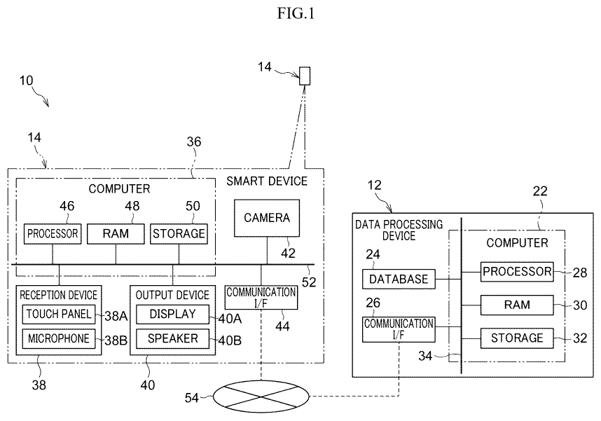

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

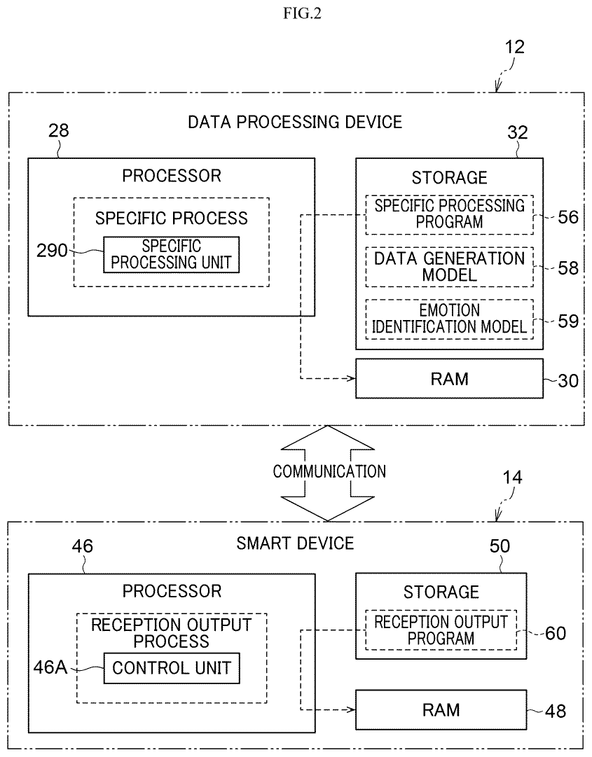

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional opponent-matching systems in networked competition environments typically rely on static, rule-based filtering and simple database queries to identify potential opponents. In such systems, a server generally receives user-input data, stores it in a database, and then executes predetermined search conditions such as matching on sport type or basic skill level. These mechanisms are limited in their ability to flexibly interpret rich user preferences, such as nuanced play style, desired opponent traits, or complex schedule and location constraints. As the amount and variety of user profile data increase, conventional architectures tend to become more rigid, harder to maintain, and less effective at returning high-quality matches.

Moreover, although generative AI models can produce sophisticated prompt-based reasoning and pattern analysis, conventional systems do not integrate these models into the core search pipeline in a structured, machine-implementable manner. Typically, any use of a generative AI model is performed manually by a human operator or in an ad hoc fashion, without a well-defined interface between structured database records and dynamically generated selection logic. As a result, the server's processing often cannot systematically leverage generative models to refine search criteria, determine selection procedures, or compute compatibility measures in a way that improves computational efficiency or match quality.

Further, existing systems frequently treat user interfaces, database storage, and AI-based processing as disconnected components. Input screens may allow users to specify available time or location only in a coarse manner, and these parameters are not tightly coupled to the matching computation. The system may fail to compute a quantitative compatibility score that jointly considers skill level, activity results, detailed opponent attributes, temporal availability, and place-of-activity information. This lack of integrated processing leads to suboptimal use of computing resources and to a degraded user experience, in which users must repeatedly adjust filters or manually inspect large lists of candidates.

Accordingly, there is a need for an improved computer-implemented matching architecture in which a processor cooperatively manages (i) structured acquisition and storage of user profile and preference information, (ii) generation of prompt sentences that encode selection conditions, (iii) interaction with a generative AI model to derive or update machine-usable selection conditions or procedures, and (iv) algorithmic computation of compatibility scores and ranking. Such an architecture should enhance the functioning of the computer system itself by enabling more adaptive, data-driven search logic, reducing manual configuration of search rules, and producing higher-quality ranking outputs using the same or fewer computing resources.

The specific processing by the specific processing unit 290 of the data processing device 12 in Example 1 is realized by the following means.

The present invention provides a server comprising a processor configured to provide, to a user via a communication terminal, a user interface that collects structured profile and preference data including competition category, past activity history, activity results, desired opponent attributes, available time, and place-of-activity information; to register or update such input data in a structured information storage using a query language; to generate, on the basis of user input data and attribute data of other participants, a prompt sentence that explicitly encodes selection conditions for candidate opponents; to input the generated prompt sentence to a generative AI model and determine, from a response of the generative AI model, machine-usable selection conditions or selection procedures for extracting candidate opponents from the structured information storage; to execute a controlled search of the structured information storage in accordance with the determined selection conditions or selection procedures to obtain a set of candidate opponents; to compute, for each candidate opponent in the set, a compatibility score based on a comparison between the user's skill level, activity results, desired attributes, available time, and place-of-activity information and corresponding information of the candidate opponent; to rank the candidate opponents according to the computed compatibility scores; and to generate display data including attribute information and activity history information of the ranked candidate opponents for presentation by the communication terminal. This enables the computer system to dynamically refine search logic using outputs of a generative AI model while operating entirely on structured data, to perform more efficient and accurate selection and ranking of candidate opponents based on multi-dimensional compatibility measures, and to improve the overall technical performance of the matching process in terms of adaptability, precision, and computational resource utilization.

The term “system” refers to a combination of hardware and software components that cooperate to execute information processing functions including data input, storage, search, and output.

The term “processor” refers to one or more hardware computation units, such as a central processing unit or an execution core, configured to execute machine-readable instructions implementing the functions described in the claims.

The term “communication terminal” refers to an electronic device operated by a user, such as a portable device or a stationary device, that executes a program for presenting a user interface and communicating with a server over a communication network.

The term “browsing program” refers to an application program executed by the communication terminal that retrieves, interprets, and displays content obtained from a server, and that sends user input data to the server, such as a web browser or an equivalent client program.

The term “user interface” refers to a logical arrangement of input and output elements presented by the browsing program, including screens, input fields, buttons, and controls, which enable the user to input information and view information processed by the system.

The term “screen” refers to a display state of the user interface that includes visual components such as text, graphics, and input controls rendered by the browsing program for interaction by the user.

The term “competition category” refers to a classification of an activity in which opponents participate, including but not limited to sports, games, or other competitive activities.

The term “past activity history” refers to structured data representing prior participation of a user in competitions or activities, including identifiers of events, dates, and contextual information.

The term “activity results” refers to structured data representing outcomes achieved by a user in past activities, including metrics such as wins, losses, scores, rankings, or performance indicators.

The term “desired opponent attributes” refers to characteristics specified by a user as preferences for an opponent, including but not limited to skill level, play style, technical strengths, or behavioral traits.

The term “available time” refers to one or more time periods during which a user is able or willing to participate in a competition, represented in a machine-readable temporal format.

The term “place-of-activity information” refers to data indicating one or more locations where a user can participate in a competition, such as facility identifiers, geographic regions, or venue descriptors.

The term “input information” refers to any data that is received from the user interface through the communication terminal and transmitted to the server for processing, including profile data, preferences, and constraints.

The term “communication unit” refers to a combination of hardware and software components configured to send and receive data between the server and the communication terminal over a communication medium.

The term “structured information storage unit” refers to a data storage subsystem, such as a relational database or an equivalent structured data store, that stores records in accordance with a defined schema and supports queries using a query language.

The term “query language” refers to a formal language used by the processor to retrieve, insert, update, or delete data in the structured information storage unit, including but not limited to a relational query language.

The term “attribute information” refers to data items describing characteristics of users or candidate opponents, including identity-related data, competition categories, skill-related metrics, temporal availability, and spatial information.

The term “other participants” refers to users different from the current user, whose attribute information is stored in the structured information storage unit and may be considered as candidate opponents.

The term “prompt sentence” refers to a machine-generated or machine-processed textual or tokenized expression that encodes selection conditions, constraints, or instructions intended for input to a generative AI model.

The term “selection conditions” refers to criteria used to determine whether a participant should be considered a candidate opponent, including constraints on competition category, skill, schedule, location, or desired attributes.

The term “candidate opponents” refers to a subset of participants that satisfy at least some selection conditions and are considered as potential opponents for the user.

The term “generative AI model” refers to a machine-learned computational model, such as a neural network-based generative model, configured to generate text or other outputs in response to prompt sentences.

The term “response obtained from the generative AI model” refers to any output data provided by the generative AI model when a prompt sentence is input, including natural language text, structured instructions, or parameter values.

The term “selection procedure” refers to a sequence of operations or rules, derived or updated at least in part from the generative AI model's response, that are executed by the processor to extract candidate opponents from the structured information storage unit.

The term “set of candidate opponents” refers to a collection of data records representing participants identified by executing the selection conditions or selection procedure on the structured information storage unit.

The term “skill level” refers to a representation of a user's or opponent's proficiency in a competition category, expressed by discrete levels, numerical ratings, or derived performance indicators.

The term “compatibility score” refers to a numerical or ordinal value computed for each candidate opponent based on a comparison between the user's profile and the candidate's profile, indicating a degree of suitability as an opponent.

The term “degree of compatibility” refers to a measure, derived from the compatibility score, that reflects how well a candidate opponent matches the user with respect to multiple factors including skill, results, attributes, time, and place.

The term “ranking” refers to an ordering of candidate opponents determined according to their compatibility scores or degrees of compatibility.

The term “display information” refers to data formatted for presentation to the user, including selected attribute information and past activity history information of candidate opponents.

The term “screen data” refers to data structures generated by the processor that are interpretable by the browsing program to render the display information on the communication terminal.

The term “search process” refers to the execution of one or more operations, including data retrieval and filtering in the structured information storage unit, according to selection conditions or selection procedures.

The term “extraction criteria” refers to rules or parameters that define which participants from the structured information storage unit are to be included in or excluded from the set of candidate opponents.

The term “updated extraction criteria” refers to extraction criteria that have been modified based on attribute information or responses from the generative AI model, enabling refined selection of candidate opponents.

In one embodiment, the server, the terminal, and the user cooperate to realize the claimed system by executing dedicated software modules on specific hardware components connected via a communication network.

The server uses one or more processor cores of a general-purpose computing device, such as a rack-mounted computer or a virtual machine in a data center, to execute an operating system, a web server program (for example, a generic HTTP server), an application execution environment for a scripting language (for example, a generic server-side scripting engine), a database management system (for example, a generic relational database engine), and a runtime environment for a programming language used for matching logic (for example, a generic interpreted language runtime). The server further uses a hardware network interface controller to send and receive data packets according to an internet protocol. The terminal uses a processor, a display device, a pointing device or touch panel, and a memory unit to execute a browsing program, such as a generic web browser, that can render markup language documents, execute client-side scripts, and establish secure communication sessions with the server. The terminal can be implemented as a handheld device, a portable computer, or a stationary computer.

The user operates the terminal to interact with the server. The user uses the browsing program to access a network address provided by the server. The terminal displays a user interface generated by the server. The terminal presents screens that include input fields, selection lists, and buttons. The user inputs a competition category, past activity history, activity results, desired opponent attributes, available time, and place-of-activity information into the user interface. The terminal converts the user's actions into structured request data, such as key-value pairs, and transmits the structured data to the server using a communication protocol such as HTTPS.

The server receives the structured request data using the network interface controller and passes the data to the web server program. The server uses the server-side scripting engine to parse the request data, extract input fields, and validate the input. The server determines whether each mandatory field is present, whether numeric values such as wins, losses, or time indices are within an allowed range, and whether category identifiers correspond to defined entries in a configuration table. The server sanitizes text fields to remove or encode control characters and special symbols that could cause injection attacks. The server then transforms the validated input into a structured format suitable for storage, such as rows for tables in the relational database.

The server uses the relational database engine to persist the user's data. The server maintains a schema that includes at least the following tables: a user table that stores identifiers, base profile attributes, and competition categories; an activity history table that stores event-level results with foreign keys referencing the user table; a preference table that stores desired opponent attributes, including skill-level range, play style, and special traits; a schedule table that stores available time slots in a normalized temporal representation; and a location table that stores place-of-activity information, such as venue identifiers and geographic coordinates. The server uses a query language to insert or update records in these tables. The server maintains indexes on frequently used columns, such as competition category, skill level, and location area, to accelerate subsequent search operations.

The server uses a dedicated matching module implemented in the interpreted language runtime to perform advanced opponent selection and ranking. The server uses a database connector library to retrieve user profiles, activity histories, preferences, schedules, and location data from the relational database. The server transforms the retrieved data into in-memory data structures such as arrays, lists, and dictionaries. The server normalizes numeric fields, for example by converting wins and losses into win ratios and by mapping discrete skill-level labels to numeric scores. The server encodes categorical fields such as play style and traits into feature vectors, for example using one-hot encoding or frequency-based indices. The server encodes time slots into discrete temporal bins and encodes locations into region identifiers or coordinate grids.

The server generates a prompt sentence using the matching module and a prompt-generation module. The server constructs the prompt sentence as a text string that includes explicit selection conditions and constraints. For example, the server composes a prompt such as: “Design a selection rule that, for a given user with sport type=soccer, skill level=advanced, wins=20, losses=10, available time=weekday evenings, and desired opponent traits=strong in dribbling, selects appropriate opponent candidates from a relational database that stores users'sport types, skill levels, win-loss records, traits, schedules, and locations, and outputs a compatibility scoring formula and filtering conditions.”

The server uses a communication client for a generative AI model to send the prompt sentence to a generative AI model hosted on a separate computing resource or integrated into the server environment. The generative AI model can be implemented as a multi-layer neural network, such as a transformer-based language model. The model comprises an embedding layer that maps tokens to dense vectors, multiple self-attention layers that compute contextualized representations of the input sequence, feedforward layers that transform these representations, and an output layer that predicts token probabilities. The model is trained on training data including natural language instructions and corresponding structured reasoning patterns.

The server receives a textual response from the generative AI model. The server parses the response to extract structured elements, such as recommended filtering conditions, weighting coefficients for features, and compatibility scoring formulas. For example, the response may specify that only opponents with the same competition category and within a defined skill-level difference are to be considered; that win-loss ratios are to be compared using an absolute difference metric; and that trait similarity is to be assessed using a keyword-overlap metric. The response may further specify numerical weights, such as assigning 0.4 weight to skill-level difference, 0.3 weight to trait similarity, 0.2 weight to win-loss similarity, and 0.1 weight to schedule and location overlap.

The server converts these textual descriptions into machine-usable selection conditions and selection procedures. The server constructs structured rules, for example represented as configuration objects or rule lists, and stores them in a rule configuration table in the relational database or in memory. The server thereby alters the behavior of the matching module without requiring manual reprogramming of hard-coded rules. This dynamic configuration of selection logic constitutes an improvement in computer functionality, because the server can adapt its search and ranking procedures to new patterns of user behavior and data distributions while maintaining a deterministic, machine-executable pipeline.

The server applies the selection procedure to the structured information storage. The server uses the query language and rule configuration to retrieve a preliminary candidate set from the database. For example, the server uses a query to select all users with the same competition category as the querying user, with skill level values within a range difference specified by the selection conditions, and with overlapping available time slots and place-of-activity regions. By pushing coarse filtering into the query, the server reduces the number of records transmitted from the database to the matching module, thereby reducing communication load and improving processing speed.

The server then performs detailed computing on the filtered candidate set in the matching module. The server computes feature vectors for each candidate opponent, including numerical representations of skill level, win-loss metrics, temporal overlap indices, location overlap indicators, and trait-similarity scores. To compute trait similarity, the server uses a vocabulary of trait keywords and converts trait strings for the user and each candidate into binary or weighted vectors over the vocabulary. The server then computes similarity using a metric such as cosine similarity or Jaccard index on the feature vectors. The server calculates a compatibility score for each candidate by combining partial scores with the weights derived from the generative AI model response. Because the server uses a mathematically defined scoring formula, the compatibility computation is repeatable and optimizable by standard numerical methods.

In one variation, the server uses a small neural network inside the matching module to convert feature vectors into compatibility scores. The server defines a network with an input layer corresponding to concatenated feature vectors, one or more hidden layers with rectified linear unit activations, and an output layer with a scalar activation representing compatibility.

The server trains this network offline using historical match-acceptance data and user feedback. The server uses a loss function such as mean squared error or cross-entropy between predicted compatibility and ground-truth labels, and updates network weights by using a gradient-based optimization algorithm such as stochastic gradient descent or an adaptive gradient method. The server may use data augmentation techniques, such as adding noise to feature values or simulating slightly varied schedules, to improve robustness. The server thus enhances the predictive accuracy of the compatibility scoring beyond simple linear combinations, further improving the ranking quality.

The server ranks candidates by sorting their compatibility scores in descending order. The server limits the result set to a defined number of top candidates to control the volume of data sent to the terminal. The server generates display information including identifiers, competition categories, skill levels, aggregated activity results, textual descriptions of play style and traits, and simplified schedule and location summaries. The server inserts this information into structured response objects and passes them to a presentation module that constructs markup language documents and client-side script code.

The server uses the web server program to transmit the generated markup and script to the terminal. The terminal receives the response, and the browsing program renders a list or grid of ranked candidate opponents. The terminal executes the client-side script to allow interactive operations such as expanding a candidate panel to show detailed past activity history, applying local filtering conditions, or triggering a new search request with modified parameters.

The user views the ranked list of opponents and may adjust preferences directly from the same screen, such as changing a desired skill-level band or toggling specific traits. The terminal sends only the changed parameters to the server in subsequent requests. The server reuses previously stored user data and applies incremental adjustments to the selection procedure, which reduces redundant data transmission and computation. This incremental processing leads to reduced latency in updating the ranked list, which is a direct improvement in the technical performance of the matching system.

The server's integration of the generative AI model into the selection pipeline is not a mere automation of human decision-making. The server uses the generative AI model to synthesize or refine machine-readable selection rules from natural language descriptions of user preferences and data characteristics. The server then converts these rules into concrete query patterns, feature-weighting schemes, and scoring formulas that are executed using optimized database operations and numerical computations. This architecture improves computer technology because the server can automatically generate complex selection logic that would be difficult to predefine manually, while still performing matching in a structured, efficient manner that leverages index-based queries and vectorized computations. The result is a reduction in the number of database scans, an improvement in cache utilization in the matching module, and an increase in the accuracy of selection measured by, for example, acceptance ratio or user satisfaction metrics.

The server further improves data management by maintaining a clear separation between stored profile data, rule configuration data, and learned scoring parameters. The server stores each type of data in distinct tables or storage structures with explicit relationships. This separation allows the server to update selection rules or model parameters without rewriting profile data, and to perform rollback or version control for rule configurations. Such a design prevents inconsistency and reduces the risk of corrupted matching logic, contributing to a more robust information processing apparatus.

In another embodiment, the server deploys multiple generative AI models or multiple versions of a model. The server selects a particular model based on system load, data domain, or historical performance. For example, the server may use a smaller generative AI model when the system is under heavy load to reduce inference time and computational cost, and may use a larger model when more detailed analysis is required. The server caches prompt sentences and responses to reuse frequently applied selection patterns, thereby reducing the frequency of model invocation and further lowering processing time and network bandwidth consumption between the server and an external AI service.

In yet another embodiment, the server refines extraction criteria over time by using feedback data. When the user accepts or rejects recommended candidates, the server records this behavior in a feedback table. The server periodically aggregates feedback data and uses the aggregated data to adjust weights or thresholds in the selection procedure. The server may also generate secondary prompt sentences to the generative AI model, such as:

“Given that users frequently accept opponents with small differences in win-loss ratios but similar skill-level labels, and reject opponents with mismatched available times, propose updated weighting coefficients for skill-level difference, win-loss similarity, trait similarity, schedule overlap, and location overlap to maximize match acceptance probability.”

By integrating the feedback into updated extraction criteria, the server continuously optimizes its internal matching algorithm. This dynamic adaptation based on real-time feedback is not achievable using static rule-based systems and leads to measurable improvements in match accuracy and processing efficiency, thus enhancing the technical performance of the computer system.

Through these embodiments, the server, the terminal, and the user cooperate to realize a system that connects structured user data, a generative AI model, and a concrete matching algorithm. The server's specific data structures, prompt-generation mechanisms, rule-conversion logic, and feature-based compatibility computations collectively provide a technical solution that improves computing efficiency, ranking accuracy, and communication performance, rather than simply automating a human conceptual process.

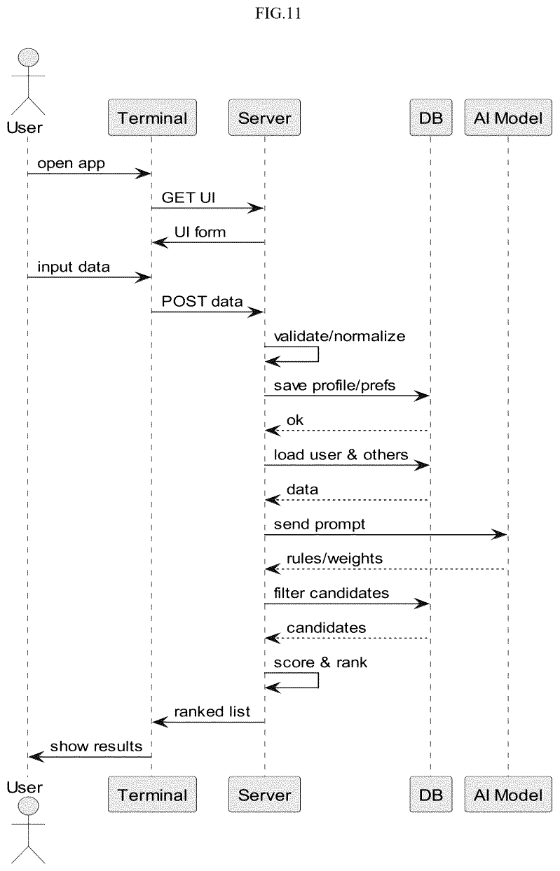

The following describes the processing flow using FIG. 11.

### Step 1:

The user operates the terminal to access the system.

The terminal sends a request to the server to obtain an initial screen. The input to this step is a network access operation (for example, entering a URL or tapping an application icon). The output of this step is an HTTP(S) request transmitted from the terminal to the server. The terminal uses a browsing program to construct the request and includes session identifiers or cookies if available.

### Step 2:

The server receives the initial request and generates a user interface screen.

The server uses a web server program and a server-side scripting engine to interpret the request. The input to this step is the HTTP(S) request received from the terminal. The server executes script logic that composes an HTML form with input fields for competition category, past activity history, activity results, desired opponent attributes, available time, and place-of-activity information. The server's processing includes selecting appropriate labels, enumerations for categories, and default values. The output of this step is a markup document and associated client-side script code sent back as an HTTP(S) response to the terminal.

### Step 3:

The terminal renders the user interface and collects user input.

The terminal uses the browsing program to parse the markup and script. The input to this step is the HTML and script provided by the server. The terminal renders visual components on the display and activates input controls. The user then provides competition information, result data, preference attributes, available time, and place-of-activity information by typing, tapping, or selecting options. The terminal records each user action as values in the form fields. The output of this step is a filled form held in the memory of the terminal.

### Step 4:

The terminal transmits structured input data to the server.

The terminal converts the filled form into structured request data, such as key-value pairs encoded in a request body. The input to this step is the internal representation of form fields (for example, sport=“soccer,” wins=20, losses=10, available time slots, location codes, and trait strings). The terminal encapsulates this data into an HTTP(S) POST request, attaches relevant headers (content type, authentication tokens), and sends the request to the server. The output of this step is the transmitted request containing user profile and preference data.

### Step 5:

The server validates and normalizes the received input data.

The server receives the POST request via the web server program and forwards it to the application logic. The input to this step is the structured form data as transmitted by the terminal. The server parses the request body to extract each field. The server performs input validation by checking mandatory fields, data types (for example, integer checks for wins and losses), and allowed ranges or enumerations for categories and skill levels. The server also sanitizes text data by removing or encoding special characters. The server then normalizes values, for example converting textual time expressions into standardized time-slot indices and mapping skill-level labels to numeric scores. The output of this step is a validated and normalized data set representing the user's profile and preferences.

### Step 6:

The server stores the normalized data in the structured information storage unit.

The server uses a database access layer to connect to a relational database. The input to this step is the validated and normalized user data from Step 5. The server determines which tables need to be updated (for example, user table, activity history table, preference table, schedule table, and location table). The server constructs and executes query-language statements to insert new records or update existing records, using prepared statements and parameter binding. The server may also update index structures automatically maintained by the database engine. The output of this step is a set of stored records in the structured information storage unit, with unique identifiers and referential links between tables.

### Step 7:

The server retrieves user data and candidate data for matching.

The server initiates a matching operation when new or updated preferences are stored, or when the user explicitly requests matching. The input to this step is the user identifier and the stored records in the relational database. The server issues query-language commands to retrieve the current user's profile, past activity history, preferences, schedule, and locations, as well as attribute records for other participants that share at least the same competition category. The server may apply preliminary filters in the database query (for example, matching competition category and excluding the current user). The output of this step is a dataset of the current user's structured information and a preliminary set of other participants'structured information.

### Step 8:

The server generates a prompt sentence for a generative AI model. The server uses a prompt-generation module to convert the retrieved data and system configuration into a natural-language specification. The input to this step is the structured user data, candidate distribution statistics, and optionally prior rule configurations. The server concatenates relevant fields into a textual description, including constraints and objectives.

For example, the server constructs a prompt sentence such as:

“Design a selection rule that, for a given user with sport type=soccer, skill level=advanced, wins=20, losses=10, available time=weekday evenings, and desired opponent traits=strong in dribbling, selects appropriate opponent candidates from a relational database that stores users'sport types, skill levels, win-loss records, traits, schedules, and locations, and outputs a compatibility scoring formula and filtering conditions.”

The server may include additional context about existing filters or performance goals (for example, limiting processing time or maximum candidate count). The output of this step is a text-form prompt sentence ready to be sent to a generative AI model.

### Step 9:

The server sends the prompt sentence to the generative AI model and receives a response.

The server uses a model client module to interface with the generative AI model, either locally or via a network service. The input to this step is the prompt sentence generated in Step 8. The server encodes the prompt into tokens as required by the model's interface and issues an inference request. The generative AI model, implemented as a neural network, processes the tokens and returns a textual response. The server receives the response string. The output of this step is the textual response containing candidate selection rules, suggested filters, and recommended weighting parameters.

### Step 10:

The server parses the model response and constructs machine-usable selection conditions.

The server processes the textual response using a parser or pattern-matching logic. The input to this step is the response string from the generative AI model. The server identifies explicit filter criteria (for example, “same sport,” “skill level within ±1,” “overlapping available time and location”) and numerical weighting factors for features (for example, weights for skill difference, win-loss similarity, trait similarity, schedule overlap, and location overlap). The server maps these elements into structured rule objects or configuration records and may store them in a rule configuration table. The server also verifies that extracted rules are syntactically valid and consistent with the database schema. The output of this step is a set of structured selection conditions and selection procedures in a machine-readable format.

### Step 11:

The server filters candidate opponents in the structured information storage unit.

The server applies the machine-usable selection conditions to the relational database. The input to this step is the rule configuration derived in Step 10 and the previously retrieved or retrievable participant data. The server builds query-language statements that implement the filters (for example, WHERE clauses for competition category, skill-level range, schedule overlap, and location region). The server executes these queries to obtain a reduced candidate set. The data processing in this step consists of relational operations, such as joins between user, schedule, and location tables, and application of boolean predicates based on selection conditions. The output of this step is a set of candidate opponent records that satisfy the basic selection criteria.

### Step 12:

The server computes feature vectors and compatibility scores for each candidate opponent.

The server uses a matching module to perform numerical computations. The input to this step is the filtered set of candidate records and the user's structured data. The server converts each candidate's attributes into numerical and categorical features, including encoded skill level, win-loss metrics, schedule overlap indices, location overlap indices, and trait-similarity scores. For trait similarity, the server tokenizes trait strings, maps them to indices in a trait vocabulary, and generates vectors for the user and each candidate. The server then computes similarity metrics such as cosine similarity or Jaccard index. The server combines feature values according to the weights obtained from the generative AI model. When a neural scoring sub-model is used, the server feeds the feature vectors into the network to obtain compatibility scores. The data processing involves vector multiplications, activation functions, and aggregation operations. The output of this step is a list of candidate opponents with associated compatibility scores.

### Step 13:

The server ranks the candidate opponents.

The server orders the candidates by their compatibility scores in descending order. The input to this step is the list of candidates with computed scores from Step 12. The server uses a sorting algorithm to arrange the list and may apply thresholds or caps to limit the number of results. The server may also compute secondary metrics, such as diversity measures, and adjust the ranking accordingly. The output of this step is a ranked list of candidate opponents, each with identifiers and summary metrics.

### Step 14:

The server assembles display information and generates response data.

The server constructs presentation-ready records from the ranked candidate list. The input to this step is the ranked list of candidates and the underlying attribute data retrieved from the database. The server selects fields to display, such as competition category, skill level, summarized win-loss results, representative traits, and simplified schedule and location information. The server formats these fields into a structured response (for example, an HTML page or another markup structure) and includes client-side scripts to enable interaction. The output of this step is a response document containing both the display information and logic for the terminal to present and manage the list.

### Step 15:

The terminal renders the ranked opponent list and supports user interaction.

The terminal receives the response document from the server. The input to this step is the markup and script generated in Step 14. The browsing program parses the document and draws the visual components representing each candidate opponent in ordered form. The terminal executes client-side scripts to attach event handlers for actions such as expanding details, changing filters, or initiating a match request. The output of this step is a rendered screen showing the ranked candidates and an active user interface ready for further user operations.

### Step 16:

The user reviews the candidates and optionally adjusts conditions or selects an opponent.

The user inspects the ranked list on the terminal display. The input to this step is the rendered user interface with candidate data. The user may scroll, open detail views, and compare compatibility indicators. If the user wishes to adjust conditions, the user modifies preference controls (for example, changing desired skill-level range or selecting additional traits). If the user selects an opponent, the user triggers an action such as pressing a “request match” button. The output of this step is a new set of input commands that the terminal will package and send to the server in subsequent requests, which then re-enter the processing flow from an appropriate earlier step.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional opponent-matching techniques in competitive activities typically rely on simple rule-based filters and static search queries executed against relational or document-oriented data stores. In such approaches, a server generally applies fixed conditions such as competition type, self-declared skill level, and geographic region to retrieve a set of candidate opponents. These techniques suffer from several technical problems when implemented on information processing systems.

First, the server is required to process large volumes of heterogeneous user data, including competition history, performance data, temporal availability, and multiple types of opponent preference conditions. Conventional matching logic typically operates as a sequence of rigid query and sorting operations that do not leverage the semantic relationships among these diverse data elements. As the number of users and the dimensionality of the matching conditions increase, the rule-based logic becomes increasingly complex, leading to higher processor load, inefficient memory access patterns, and increased latency in generating recommended opponents.

Second, existing systems often treat natural language descriptions of user preferences and contextual information, such as play style descriptions or qualitative constraints, as opaque text fields that are not effectively interpreted by the matching algorithm. This results in an underutilization of stored data, and forces the user to conform to limited, pre-defined categories that may not accurately reflect their intent, thereby degrading the quality and relevance of the recommendations.

Third, in conventional systems, the interaction between the application server and any machine learning component is often ad hoc and not systematically integrated into the data processing pipeline. For example, a machine learning component might be invoked merely as an isolated scoring function on already filtered candidates, without a unified representation of competition history, availability, location information, and user-specified conditions. Such architectures limit the ability of the system to exploit advanced language models or generative models, and often require separately maintained feature-engineering code, resulting in duplication of computation, increased maintenance overhead, and reduced adaptability to new data types.

Fourth, in many known implementations, prompt construction for generative AI models, when used at all, is performed in an unstructured or manual manner, without programmatically binding the underlying structured data (e.g., stored competition history and availability information) to the prompt contents. This leads to inconsistent or incomplete inputs to the AI model, increased error rates in recommendation generation, and makes it difficult to guarantee deterministic coverage of key constraints such as time and location. As a consequence, the server may need to perform additional corrective filtering and verification after AI inference, which further increases processing latency and complexity.

Accordingly, there is a need for an improved information processing system, and in particular an improved server-side data processing architecture, that systematically integrates structured user data with dynamically generated prompt sentences addressed to a generative AI model. Such a system should enable the processor to convert stored competition history, performance data, availability information, and multidimensional opponent preference conditions into a unified, machine-interpretable representation, and to use a generative AI model to evaluate and rank candidate opponents in a way that reduces the computational burden on the server and improves matching relevance and response time. There is also a need for a mechanism that programmatically constructs and supplies prompts that include both structured and contextual constraints as evaluation conditions, thereby improving the efficiency and reliability of the overall computer-implemented matching process.

The specific processing by the specific processing unit 290 of the data processing device 12 in Application Example 1 is realized by the following means.

The present invention provides a server comprising a processor and a storage device, the processor being configured to present, to a user terminal, an information input/output screen that accepts input of a competition type, past competition history, performance information, and multiple opponent preference conditions including capability conditions, regional conditions, play-style conditions, available time periods, and desired location information; to store user input information acquired via the information input/output screen as structured data in an information storage area of the storage device; to retrieve, from the information storage area, search target information corresponding to the competition type, the performance information, and the opponent preference conditions; to extract, based on the retrieved search target information, a candidate set including a plurality of candidate opponents; to automatically generate a prompt sentence that encodes, in a machine-interpretable textual form, the competition type, the structured competition history, the performance information, the available time periods, the desired location information, and the opponent preference conditions together with identifiers and attributes of the candidate opponents; to input the generated prompt sentence and the candidate set into a generative AI model so as to cause the generative AI model to evaluate and rank the candidate opponents in the candidate set according to the encoded evaluation conditions and to generate explanatory information for the ranked candidate opponents; and to determine, based on an evaluation result output from the generative AI model, one or more of the candidate opponents as recommended opponents in ranked order and to transmit information regarding the recommended opponents and the explanatory information to the user terminal for presentation. This enables the server to transform heterogeneous structured user data and multiple matching constraints into a unified prompt-driven evaluation process executed by the generative AI model, thereby reducing reliance on complex rule-based matching logic, improving utilization of stored competition and availability data, decreasing computational overhead and latency in generating ranked recommendations, and enhancing the relevance and explainability of opponent matching results in a computer-implemented environment.

The term “system” refers to a computer-implemented arrangement including at least one processor, at least one storage device, and one or more communication interfaces that cooperate to execute the functions described in the claims.

The term “processor” refers to one or more hardware processing units, such as a central processing unit or a graphics processing unit, configured to execute instructions stored in a memory to perform data processing operations.

The term “storage device” refers to any non-transitory computer-readable medium, such as a semiconductor memory, magnetic storage, or optical storage, configured to store programs, structured data, and intermediate processing results.

The term “information storage area” refers to a logical data region within the storage device, such as a table, collection, or file space, in which user-related information and candidate opponent information are stored as structured data.

The term “user” refers to an individual or entity that operates a user terminal to input competition-related information and to receive recommended opponent information from the system.

The term “user terminal” refers to an information processing apparatus, such as a portable communication device or a general-purpose computing device, configured to communicate with the server and present user interfaces.

The term “information input/output screen” refers to a graphical or textual user interface presented on a display of the user terminal, through which the user can input information and receive information from the system.

The term “competition type” refers to a category of competitive activity, such as a sport or game classification, used as a basis for selecting and matching opponents.

The term “competition history” refers to information representing past participation of the user in competitive activities, including at least identifiers of past events, dates, and opponent identifiers.

The term “performance information” refers to data representing outcomes or quantitative measures of the user's past competitions, including scores, win-loss records, rankings, or other performance indicators.

The term “opponent preference conditions” refers to one or more conditions specified by the user that characterize a desired opponent, including capability conditions, regional conditions, play-style conditions, available time periods, and desired location information.

The term “capability conditions” refers to conditions relating to a skill or ability level of a desired opponent, including classifications such as beginner, intermediate, advanced, or equivalent quantitative measures.

The term “regional conditions” refers to conditions relating to geographical attributes of a desired opponent, including residence area, activity area, or region in which the opponent is able to participate in a competition.

The term “play-style conditions” refers to conditions describing preferred behavioral or tactical characteristics of a desired opponent during competition, including aggressiveness, defensiveness, or other style-related descriptors.

The term “available time period” refers to a time interval or set of time intervals indicating when the user or a candidate opponent is able to participate in a competition.

The term “desired location information” refers to information specifying one or more preferred competition locations, such as a facility type, area, or venue-related constraints.

The term “structured data” refers to data that is stored according to a predefined schema or format, such as records, fields, and relations, enabling programmatic querying and retrieval.

The term “search target information” refers to a subset of the structured data retrieved from the information storage area and used as input for extracting candidate opponents according to specified conditions.

The term “candidate set” refers to a group of one or more candidate opponents, each associated with corresponding attributes, that are subject to evaluation and ranking.

The term “candidate opponent” refers to a potential opponent for the user, represented by structured data including at least identifiers, competition-related attributes, and availability information.

The term “machine learning processing apparatus” refers to a hardware and software configuration capable of executing machine learning models, including generative models, to process input data and produce evaluation or generation results.

The term “generative AI model” refers to a machine-learned model configured to generate output data, including evaluation scores, rankings, and explanatory text, based on input data such as a prompt sentence and candidate attributes.

The term “prompt sentence” refers to a text string or sequence of tokens that encodes instructions, context, and constraints for input to the generative AI model, including structured information about the user, candidate opponents, and evaluation conditions.

The term “evaluation conditions” refers to conditions embedded in or associated with the prompt sentence that the generative AI model is instructed to consider when evaluating and ranking candidate opponents.

The term “evaluation result” refers to output data generated by the generative AI model that includes at least ranking information, scores, or selection decisions relating to the candidate opponents.

The term “recommended opponent” refers to a candidate opponent selected by the system, based on the evaluation result, as suitable for the user under the specified conditions.

The term “ranked order” refers to an ordering of candidate opponents or recommended opponents according to relative evaluation scores or priorities determined by the generative AI model and post-processing logic.

The term “explanatory information” refers to information, typically in natural language form, that describes reasons or factors for selecting or ranking candidate opponents, generated at least in part by the generative AI model.

In one embodiment, a server implements the claimed system using a hardware platform that includes at least one central processing unit (CPU), at least one graphics processing unit (GPU), a main memory, a non-transitory storage device, and a network interface. The server executes an operating system such as a general-purpose server operating system, and an application framework such as a web application framework. The storage device stores application programs, trained parameters of a generative AI model, and structured user data. The network interface connects the server to one or more terminals operated by users via a packet-switched communication network.

A terminal is, for example, a smartphone, a tablet device, a wearable device, or a personal computer, equipped with a display, an input device, a memory, and a communication interface. The terminal executes an application program, such as a native mobile application or a web browser, that communicates with the server. The terminal presents to a user an information input/output screen and transmits user input data to the server using a communication protocol such as HTTPS. The user operates the terminal to input competition types, competition history, performance information, and opponent preference conditions, and to receive and display recommended opponents.

The server uses a relational database management system or a document-oriented database system as the information storage area on the storage device. The server stores user-related information in normalized tables or collections, including a user table that stores user identifiers, competition types, and baseline attributes, a competition history table that stores match-level records, and a preference table that stores opponent preference conditions, available time periods, and desired location information. The server defines indexes on key fields such as competition type, geographic region, and skill level, thereby enabling efficient retrieval of search target information. By structuring the data into such relational or document-oriented schemas, the server reduces the number of full scans required to identify candidate opponents and improves memory locality during query processing.

The server implements a generative AI model using a machine learning framework such as a neural-network library. In one embodiment, the generative AI model is realized as a transformer-based neural network, including an embedding layer, a plurality of self-attention layers, feed-forward layers, and an output projection layer. The server stores trained weight parameters of the generative AI model in the storage device and loads them into the memory at runtime. The server invokes the generative AI model on a GPU to accelerate matrix-multiplication operations in the attention and feed-forward layers, thereby reducing inference time when evaluating large candidate sets.

The server represents input to the generative AI model as a sequence of tokens derived from a prompt sentence concatenated with structured information about the user and candidate opponents. The server uses a tokenizer, such as a byte-pair encoding or similar sub-word tokenizer, to map characters of the prompt sentence into integer token identifiers. The server then feeds the tokenized sequence into the generative AI model. The generative AI model computes, for each layer, attention weights between tokens, and propagates contextualized representations forward to produce an output sequence from which ranking scores and explanatory information for candidate opponents are decoded.

The server constructs the prompt sentence by programmatically assembling textual segments that encode competition type, competition history, performance information, availability constraints, and preference conditions. For example, the server may generate a prompt sentence of the following form:

“You are a matching assistant for sports opponents. Based on the following player profile, preferences, and candidate list, evaluate and rank the candidates and explain your reasoning.

Player profile:
Sport: tennis
Level: intermediate
Total matches: 50 (30 wins, 20 losses)
Typical score: close sets, often 6-4 or 7-5

### Preferences:

Desired opponent level: intermediate
Region: Tokyo
Available time: weekday evenings
   Candidate list:
[Summarized attributes of candidate players follow]
Task: Rank the candidates from best to worst match for the player, assign a score between 0 and 100 to each candidate, and provide one concise reason for each recommendation.”

The server converts structured competition history and preference data into textual summaries that are concatenated into the prompt sentence. This conversion allows the generative AI model, which is optimized for sequence processing, to interpret heterogeneous features (such as win-loss ratios, score distributions, and time availability) within a unified token sequence. This design differs from conventional rule-based filtering, which processes each feature independently using fixed if-then rules, and instead exploits cross-feature correlations learned during model training.

The server trains the generative AI model offline using a training dataset that includes historical match-making records, user feedback on recommended opponents, and synthetic variations generated through data augmentation. The server defines an objective function that includes a ranking loss component, such as a pairwise ranking loss, and a language modeling loss component, which encourages coherent explanatory text. During training, the server computes gradients of the loss with respect to model parameters using backpropagation, and updates the parameters via an optimization algorithm such as stochastic gradient descent or an adaptive variant. The server may apply regularization techniques such as dropout in attention or feed-forward layers to prevent overfitting. The server can also perform data augmentation by randomizing order of candidate descriptions or by paraphrasing preference sentences while preserving semantic constraints, thus increasing robustness of the model to variations in user inputs.

The server defines evaluation conditions that are embedded into the prompt sentence in a machine-interpretable form. For example, the server encodes boundaries of available time periods as discrete time range descriptions, and encodes location constraints using standardized region names. The server also encodes capability conditions, such as “intermediate level,” into canonical textual descriptors. This encoding allows the generative AI model to attend to these constraints explicitly and adjust ranking scores accordingly. Because the evaluation conditions are part of the input sequence, the generative AI model can learn conditional dependencies that are not easily captured by fixed SQL queries or simple scoring functions.

The server performs pre-filtering of candidate opponents using structured queries executed by the database engine. For example, the server retrieves only users whose competition type matches the requested competition type, whose declared skill level falls within a specified range, and whose region matches or is adjacent to the requested region. The server further filters out users who have blocked the requesting user or have conflicting availability. This pre-filtering reduces the candidate set size from a very large user base to a manageable subset, significantly decreasing the number of candidates that must be encoded in the prompt sentence and evaluated by the generative AI model. By reducing the size of the input sequence, the server reduces GPU memory usage and improves inference throughput.

The server, after receiving the generative AI model output, parses the generated token sequence and extracts structured components that represent ranking scores and explanatory text. In one embodiment, the server instructs the generative AI model, via the prompt sentence, to output each candidate in a standardized textual format including an identifier, a score, and a reason. The server then uses a rule-based parser or a lightweight pattern-matching algorithm to map the generated text back into a structured ranking list. The server sorts the candidates by the generated score values and applies threshold criteria to discard candidates below a specified score. This integration of generative output within a structured pipeline improves the reliability of the matching process and reduces the amount of manual post-processing required.

The server transmits the final recommended opponents and their explanatory information to the terminal. The terminal displays the recommended opponents in ranked order together with reasons, such as “similar win-loss record and frequent play on weekday evenings in the same region.” The user can use these explanations to understand the basis of the system's recommendation. Because the explanations are generated by the generative AI model based on internal attention patterns over the competition history and preference conditions, they may reveal nuanced similarities that are not captured by simple numeric scores. This architecture improves computer technology itself in several ways. First, by offloading multi-dimensional evaluation and ranking to the generative AI model using the prompt sentence, the server reduces the complexity and depth of server-side rule-based logic. Instead of executing a large number of nested conditional branches and joins in database queries, the server executes a limited set of queries to form a candidate set and then performs high-level evaluation by a single inference call. This reduces CPU cycles spent on rule evaluation and reduces code maintenance complexity. Second, by encoding multiple heterogeneous features into a unified sequence, the server achieves better CPU cache utilization and GPU utilization, because the generative AI model executes standardized matrix operations rather than irregular branching. This leads to faster processing of matching requests under heavy load.

Third, by using a transformer-based generative AI model that has been trained with a ranking loss, the server improves matching accuracy compared to conventional similarity metrics based solely on Euclidean distance or manually defined weights. The model can consider complex patterns, such as a user who frequently engages in close matches with slightly stronger opponents, and can recommend opponents that match this pattern even if conventional similarity metrics would consider them dissimilar. This reduces error rates in match quality, which in turn reduces the frequency of user-initiated re-searches and thus reduces overall network and computation load.

Fourth, because the server programmatically constructs the prompt sentence from structured data, the system reduces human error and variability in prompting compared to manual prompt-writing. The server guarantees that key constraints, such as available time periods and desired location information, are always encoded in a consistent format in the prompt. This consistency enables the generative AI model to learn stable mappings from constraints to ranking behavior, further improving prediction reliability and response time.

Fifth, the server differs from a mere automation of human decision-making, because the internal processing uses high-dimensional vector representations, attention-based weighting, and gradient-based learning that have no direct analog in human manual reasoning. The server executes specific operations such as multi-head self-attention computations, residual connections, and layer normalizations, which systematically integrate information across thousands of tokens in parallel. This parallel, non-intuitive data processing method leads to technical effects such as improved scalability with respect to the number of users and improved robustness to noisy or incomplete user data.

In an alternative embodiment, the server implements the generative AI model as a sequence-to-sequence architecture with separate encoder and decoder modules. The encoder receives a structured representation of candidate opponents and their attributes, while the decoder receives a condensed prompt sentence and generates a ranking description. In another variation, the server couples the generative AI model with a traditional gradient-boosted decision tree model that consumes numeric features derived from competition history. The server fuses scores from both models according to a learned or heuristic rule, which further improves accuracy while maintaining acceptable latency.

In yet another embodiment, the server adapts the generative AI model to different competition types by fine-tuning model parameters on type-specific datasets. The server maintains separate fine-tuned parameter sets for different families of competitions in the storage device and selects an appropriate parameter set at inference time based on the requested competition type. This approach allows the server to exploit domain-specific patterns while reusing a common base architecture.

The terminal may also implement caching of recently received recommendation results and associated prompt segments, enabling the server to recognize repeated or similar requests and reuse prior generative AI model outputs when appropriate. In such cases, the server compares hashed representations of the prompt sentence and candidate set, and if a match is found, retrieves cached ranking results from the storage device instead of invoking a new generative AI model inference. This reduces GPU utilization and network traffic between the application layer and the AI inference layer.

The user interacts with the system by adjusting preference conditions and observing how recommendations change in real time. Because the server processes preference updates by recomputing only the prompt sentence and re-using stored competition history, the response latency is reduced compared to re-running full database-wide searches. The combined use of pre-filtering, prompt construction, transformer inference, and structured post-processing yields a technical effect of more efficient data management and more accurate opponent recommendation under realistic large-scale deployment conditions.

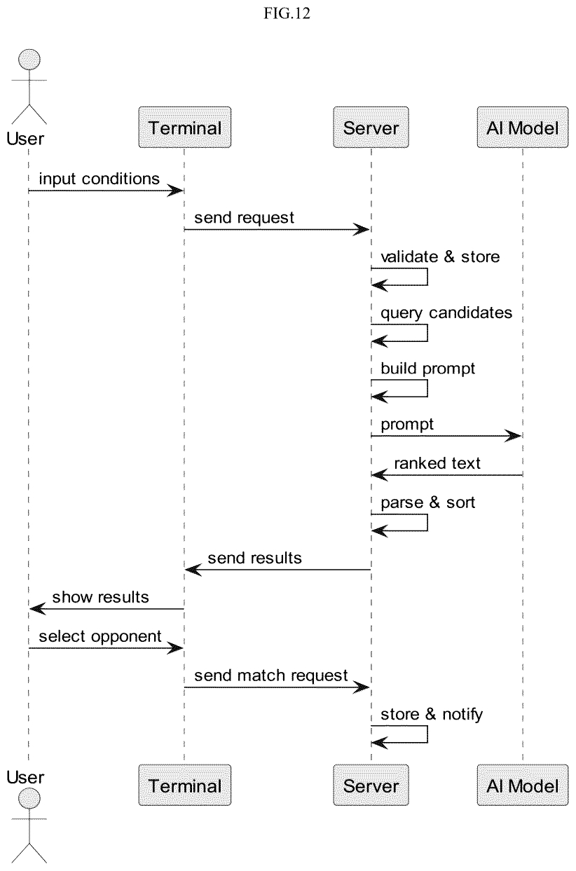

The following describes the processing flow using FIG. 12.

### Step 1:

User operates the terminal to input matching conditions.

User selects a competition type on the information input/output screen displayed on the terminal and inputs competition history, performance information (for example, total matches, wins, losses, and typical scores), and opponent preference conditions such as capability conditions, regional conditions, play-style conditions, available time periods, and desired location information. The input of this step is raw user-entered values via UI components (text fields, selection lists, sliders, date/time pickers). The output of this step is a structured request object held in the terminal's memory (for example, a key-value map) representing all entered parameters. Terminal converts each UI field into typed values (strings, integers, time ranges) and serializes them into a structured data format suitable for transmission.

### Step 2:

Terminal transmits the structured request to the server.

Terminal takes the structured request object as input and performs client-side validation (for example, required-field checks and range checks). Terminal then serializes the data into a message format such as JSON and sends it to the server via a secure communication channel using a protocol such as HTTPS. The input of this step is the structured request object produced in Step 1; the output is a network message transmitted over the communication interface to the server. Terminal uses a networking library to open a connection, write the serialized bytes to a socket buffer, and close the request.

### Step 3:

Server validates and normalizes the received user data.

Server receives the network message as input from the communication interface and parses the serialized data into an internal data structure, such as an object containing competition type, competition history, performance information, and opponent preference conditions. Server performs validation operations on this parsed structure, including verifying that the competition type belongs to a supported set, that numeric fields are within allowable ranges, and that time ranges and location formats are valid. Server also normalizes text fields (for example, converting to canonical labels for skill level and region) and converts date/time values into a unified time standard. The output of this step is a validated and normalized user profile and preference structure, which the server stores temporarily in working memory.

### Step 4:

Server stores normalized user data into the information storage area.

Server takes the validated and normalized structure as input and maps each logical field to corresponding columns or attributes in the database schema. Server then executes data-manipulation operations, such as insert or update, on relational tables or collections representing users, competition history, and preferences. During this process, the server may decompose complex objects (for example, a list of past matches) into multiple rows and attach foreign keys pointing to the user identifier. The server also updates or creates indexes on key columns (for example, competition type and region) if needed. The output of this step is a set of persistent records stored in the information storage area that can be efficiently queried later.

### Step 5:

Server retrieves search target information and performs pre-filtering of candidates.

Server uses the stored user data as input to generate database queries that retrieve candidate opponents. Server constructs structured queries that filter records in the user and preference tables according to at least competition type, capability conditions, regional conditions, and basic availability constraints. The server may also use performance information (for example, win-loss ratio) to exclude candidates that are far outside a target skill range. The input of this step is the requesting user's normalized profile and preference structure along with the database contents; the output is a candidate set, represented as a list of candidate opponent records with attributes such as identifiers, competition attributes, performance statistics, and availability windows, held in the server's working memory.

### Step 6:

Server summarizes user and candidate data for prompt construction.

Server takes as input the requesting user's profile and the candidate set from Step 5. Server performs data aggregation and transformation operations, including computing aggregate statistics for the requesting user (for example, total matches, win ratio, distribution of scores) and condensing candidate attributes into compact textual summaries (for example, “intermediate level, region A, 60% win rate, available weekday evenings”). Server converts time-range data into human-readable phrases and normalizes numeric values to bounded ranges or categories (for example, low/medium/high win rate). The output of this step is a set of textual fragments representing the user profile, preference conditions, and candidate descriptions, all structured in a format ready to be concatenated into a prompt sentence.

### Step 7:

Server constructs the prompt sentence for the generative AI model.

Server uses the textual fragments generated in Step 6 as input and assembles them into a single prompt sentence that encodes instructions, context, and evaluation conditions for the generative AI model. Server concatenates sections such as “Player profile,” “Preferences,” and “Candidate list,” and inserts the summarized attributes of each candidate into a standardized textual pattern. For example, server generates a prompt sentence of the form: “You are a matching assistant for sports opponents. Based on the following player profile, preferences, and candidate list, evaluate and rank the candidates and explain your reasoning. Player profile: Preferences: Candidate list: Task: Rank the candidates from best to worst match for the player, assign a score between 0 and 100 to each candidate, and provide one concise reason for each recommendation.”

The output of this step is a complete textual prompt sentence stored as a character string in server memory.

### Step 8:

Server tokenizes the prompt sentence and prepares input for the generative AI model.

Server takes the prompt sentence and the structured candidate attributes as input and applies a tokenizer, such as a subword tokenizer, to convert the string into a sequence of discrete token identifiers. Server may also encode certain numeric attributes (for example, win rates or scores) into special tokens or into textual templates before tokenization. Server then packs these token identifiers into a tensor or equivalent data structure suitable for processing by the generative AI model, and moves this tensor into an accelerator memory space such as GPU memory. The output of this step is a model-ready input representation consisting of token sequences and, where applicable, associated attention masks.

### Step 9:

Server executes the generative AI model to evaluate and rank candidates.

Server takes the model-ready input representation as input and invokes the generative AI model implemented, for example, as a transformer-based neural network. The model performs a series of matrix multiplications, attention computations, and nonlinear transformations across multiple layers. Internally, the model generates contextual embeddings for each token and propagates them through feed-forward sublayers and attention heads, combining information from different parts of the prompt (for example, user profile and candidate descriptions). The model ultimately produces an output sequence of probability distributions over tokens, from which the server decodes structured information such as candidate identifiers, ranking scores, and explanatory text. The output of this step is an AI-generated text output containing, for each candidate, an assigned score and a reason or explanation.

### Step 10:

Server parses the AI-generated output into a structured ranking list.

Server takes the AI-generated text output as input and applies a parser configured to recognize the standardized output format requested in the prompt sentence (for example, “Candidate ID: X, Score: Y, Reason: Z”). Server uses pattern matching, token scanning, and string-splitting operations to extract candidate identifiers, numeric score values, and explanation fragments. Server then constructs a ranking list data structure, such as a list of records containing an opponent identifier, a score, and an explanation. The output of this step is a structured ranking list of candidate opponents derived from the generative AI model's textual output.

### Step 11:

Server post-processes and normalizes the ranking results.

Server takes the structured ranking list as input and applies additional processing, including normalization of scores to a standard range (for example, converting raw scores to values between 0 and 100), sorting the list in descending order of score, and filtering out candidates that do not meet minimum score thresholds or are otherwise unavailable (for example, blocked users or users with conflicting schedules updated after pre-filtering). Server may also cross-check candidate identifiers against current database records to ensure data consistency. The output of this step is a finalized list of recommended opponents, ordered by priority, with associated explanations.

### Step 12:

Server formats recommendation data and transmits it to the terminal.

Server takes the finalized ranked list as input and constructs a response object that includes, for each recommended opponent, display attributes (for example, nickname, level, region, summarized performance) and the explanation generated with the help of the generative AI model. Server serializes this response object into a message format such as JSON and sends it through the network interface to the terminal using HTTPS. The output of this step is a response message containing recommendation data transmitted to the terminal.

### Step 13:

Terminal receives and displays recommended opponents to the user.

Terminal takes the response message from the server as input and deserializes it into an internal data structure, reconstructing the list of recommended opponents and their explanations. Terminal then updates the user interface, rendering visual components such as lists, cards, or detail views that show the recommended opponents in ranked order. Terminal may perform local formatting of numeric scores (for example, converting them to percentages) and layout adjustments based on screen size. The output of this step is the visual presentation of recommended opponents and explanations on the terminal display.

### Step 14:

User selects a recommended opponent and initiates a match request.

User observes the displayed recommended opponents and, based on the presented scores and explanations, selects one or more opponents through UI interactions such as tapping or clicking. User may also specify additional constraints for the match request, such as preferred date and exact venue. The input of this step is the list of recommended opponents displayed on the terminal; the output is a new structured request object held in the terminal's memory representing the chosen opponent identifier and any additional match-request parameters.

### Step 15:

Terminal transmits the match request and server stores and forwards the request.

Terminal sends the structured match request object to the server via HTTPS, similar to Step 2. Server receives the match request as input, validates identifiers and parameters, and stores the request as a record in a match-request table or collection in the information storage area.

Server then identifies the opponent's terminal registration information and prepares a notification payload that includes the requester identifier, basic competition details, and requested time. The output of this step is a persistent match-request record and a notification message transmitted toward the opponent's terminal, enabling subsequent acceptance or rejection handling outside the core matching and ranking process.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional matchmaking systems for competitive activities such as sports or games typically rely on fixed database queries and static rule sets to match users. In such systems, a server usually stores user profiles and availability information in a database and then executes predefined query logic (for example, filtering by time, place, and skill level) to identify candidate opponents. However, these conventional approaches exhibit several technical limitations when implemented on general-purpose computing hardware.

First, when a large number of users and complex opponent preferences are involved, the server often needs to execute multiple, fragmented queries and application-layer filters, which leads to increased CPU load, memory usage, and latency. The server architecture tends to duplicate similar filtering and ranking logic in different modules, making it difficult to maintain consistent matching behavior and to scale the system under high traffic conditions. As a result, the responsiveness of the server degrades, and the overall throughput of the matchmaking process is reduced.

Second, conventional systems do not efficiently leverage advanced machine-based models that can interpret high-dimensional user input and ambiguous or multi-faceted opponent preferences. Even when a generative model is externally integrated, the interaction between the model and the underlying database is ad hoc: prompts are crafted manually, model outputs are loosely related to structured data schemas, and the server must perform additional reconciliation logic to align model outputs with stored records. This results in redundant processing, inconsistency between model-derived candidates and database-derived candidates, and difficulty in ensuring that the final match set accurately satisfies both temporal and spatial constraints stored in the database.

Third, when users specify both availability (date, time, and place) and detailed opponent attributes, conventional systems do not normalize these data elements in a way that is optimized for server-side searching. For example, heterogeneous time zones and location formats are often stored without consistent normalization, forcing the server to perform costly conversions at query time. This leads to inefficiencies in index utilization in the storage subsystem and increases the complexity of search control logic in the processor, thereby degrading matching performance and scalability.

Fourth, existing architectures typically treat model-based matching and database-based matching as separate pipelines. Model outputs are either used as suggestions that are not rigorously reconciled with database search results, or database search results are applied without exploiting the generative model's ability to synthesize complex constraints into a compact representation. This disjoint processing produces technical problems such as duplicative computation paths, non-deterministic match sets, and inconsistent utilization of storage indexes, all of which impair the efficiency and reliability of the computer system. Accordingly, there is a need for an improved computer-implemented system and method that integrates structured data processing with generative model processing in a unified architecture. Such a system should (i) capture user input related to activity type, history, performance, opponent attributes, and availability in a structured and normalized form suitable for storage and indexed search, (ii) generate prompt sentences for a generative model directly from stored data so that the model's output is systematically aligned with database schemas, and (iii) reconcile and integrate the generative model's candidate set with database-derived candidate sets. Through this integration, the system should reduce redundant processing, improve server-side search efficiency, enhance consistency of matching results, and thereby improve the overall operation of the computer system implementing the matchmaking service.

The specific processing by the specific processing unit 290 of the data processing device 12 in Example 2 is realized by the following means.

The present invention provides a server comprising a processor, a display device, an input device, a storage device, and a communication interface, the processor being configured to generate, by using the display device and the input device, a user interface that acquires, as structured input, information including an activity type, past activity history, past performance, opponent attributes, and date, time, and place information representing user availability; to convert the acquired input into structured data and store the structured data in an information storage area of the storage device; to normalize date and time information into a common time representation and convert place information into standardized position information suitable for indexed search; to generate, on the basis of the normalized structured data, a prompt sentence including search conditions corresponding to the availability and the opponent attributes, and to input the prompt sentence into a generative information processing model; to receive output information from the generative information processing model indicating opponent candidates, store the output information in the information storage area, and in parallel execute, by using a search control function, a database search over the normalized structured data to identify opponent candidates whose availability and attributes mutually satisfy stored conditions; and to reconcile and integrate the model-derived opponent candidates and the database-derived opponent candidates by selecting only candidates that are common to both or that satisfy combined conditions, and to generate match candidate information for each selected candidate and transmit the match candidate information as notification information to a terminal device. This enables the server to perform matchmaking by coordinating generative model processing with normalized database searching in a unified workflow, thereby reducing redundant computation, improving query efficiency and index utilization, and enhancing the consistency and reliability of opponent matching in a computer-implemented environment.

The term “system” refers to an arrangement of one or more computing devices including at least a processor, a storage device, a display device, an input device, and a communication interface that cooperate to execute matchmaking processing for activities.

The term “processor” refers to one or more hardware processing circuits, such as a central processing unit or a processing core, configured to execute instructions to perform the functions described in the claims.

The term “display device” refers to any output device, such as a monitor, touch screen, or other visual output apparatus, that is configured to present graphical or textual information to a user.

The term “input device” refers to any hardware component, such as a keyboard, pointing device, touch panel, or sensor, that is configured to receive input operations or data from a user.

The term “storage device” refers to any non-transitory computer-readable storage medium, such as a magnetic disk, optical disk, semiconductor memory, or solid-state drive, that is configured to store programs and data.

The term “information storage area” refers to a logical storage region provided in the storage device, such as a database, table, file, or memory region, in which structured data related to users, activities, and candidates is stored.

The term “communication interface” refers to a hardware and software interface, such as a network interface card and associated communication stack, that enables the system to transmit and receive data over a communication network.

The term “user interface” refers to a combination of software-controlled graphical or textual elements presented on the display device and input mechanisms on the input device that allow a user to view information and input data to the system.

The term “user” refers to an individual or an entity that interacts with the system via a terminal device in order to register activity information, specify preferences, and receive matchmaking results.

The term “terminal device” refers to any computing device, such as a mobile device, a portable terminal, or a personal computer, that communicates with the server and presents the user interface to the user.

The term “activity type” refers to a classification of an activity, such as a sport, a game, or another competitive or cooperative event, that can be selected and registered by the user.

The term “past activity history” refers to information representing prior participation of the user in one or more activities, including experience duration, participation frequency, or categories of activities.

The term “past performance” refers to information representing results or outcomes of the user's prior activities, including scores, ratings, rankings, win-loss records, or similar performance indicators.

The term “opponent attributes” refers to conditions or characteristics required by a user for a counterpart participant, including at least one of skill level, rating range, age range, gender, location, play style, or other preference parameters.

The term “availability” refers to information indicating dates, times, and places at which a user is able to participate in an activity.

The term “date and time information” refers to data indicating a calendar date and a time interval or time point at which an activity can be performed.

The term “place information” refers to data indicating a location at which an activity can be performed, including at least one of a textual address, a facility identifier, or geographic coordinates.

The term “structured data” refers to data that is organized according to a predetermined schema, such as key-value pairs, database records, or formatted objects, enabling systematic storage and retrieval.

The term “normalize” refers to processing that converts data into a standardized representation, such as converting multiple local time formats into a common time representation, or different address formats into a unified location representation.

The term “common time representation” refers to a standardized time format, such as a coordinated universal time representation or a unified timestamp format, that is used consistently within the system.

The term “standardized position information” refers to location data that has been converted into a uniform representation suitable for indexed search, such as geographic coordinates or canonical location identifiers.

The term “search conditions” refers to one or more parameters or constraints, including at least activity type, availability, place, and opponent attributes, that are used to search for candidate opponents in data stored in the information storage area.

The term “prompt sentence” refers to a sequence of characters or tokens in natural language or structured form that encodes search conditions or instructions and is input to a generative information processing model.

The term “generative information processing model” refers to a machine-implemented model, such as a generative artificial intelligence model, configured to receive a prompt sentence and to output generated information including candidate opponents or related recommendations.

The term “output information” refers to data generated by the generative information processing model in response to the prompt sentence, including but not limited to identifiers, attributes, or descriptions of opponent candidates.

The term “search control function” refers to functionality executed by the processor that performs a search over structured data stored in the information storage area according to specified search conditions.

The term “database search” refers to a process in which the processor accesses the information storage area and retrieves records that satisfy one or more search conditions using index structures or query operations.

The term “opponent candidates” refers to entities, typically other users, that are identified by either the generative information processing model or the database search as potential opponents for a given user based on the search conditions.

The term “reconcile and integrate” refers to processing in which the system compares and combines candidate sets obtained from different sources, such as a generative information processing model and a database search, to produce a unified candidate set.

The term “combined conditions” refers to conditions that are derived from or represent a logical combination of conditions used in different candidate selection processes, such as conditions from the generative model and from the database search.

The term “match candidate information” refers to information generated for each selected opponent candidate, including at least the activity type, attributes of the opponent candidate, and the date, time, and place of a proposed match.

The term “notification information” refers to data that encapsulates match candidate information and is transmitted by the system to a terminal device for presentation to a user.

The term “present” refers to causing information to be visually, audibly, or otherwise perceptibly output by a display device or an associated output mechanism so that a user can perceive the information.

The server according to one embodiment operates as a matchmaking platform for competitive activities using a combination of structured database processing and a generative AI model. The server includes at least one processor, a main memory, a non-transitory storage device, a network interface, and is connected to one or more terminal devices operated by users. The terminal is, for example, a smartphone, a tablet computer, or a personal computer equipped with a display and an input device such as a touch panel, keyboard, or pointing device.

The terminal executes an application, such as a native mobile application or a web browser running a web application, to present a user interface. The terminal uses a display to show input forms and uses an input device to acquire text, selections, and gestures from the user. The terminal includes an application logic layer implemented, for example, using Java or Kotlin in an Android environment, Swift in a mobile OS environment, or JavaScript in a browser environment. The terminal converts user input into a structured representation and transmits it to the server over a communication network such as the Internet, using HTTPS and standard communication libraries.

The user uses the terminal to select an activity type (for example, tennis, soccer, or a board game), input past activity history (such as years of experience and play frequency), and input past performance (such as ranking, win ratio, or score level). The user additionally specifies opponent attributes, including skill level range, desired age range, preferred rating band, or similar properties, and availability information specifying dates, start times, end times, and places where the user is willing and able to play. The terminal internally manages this information as key-value pairs in an application-level data structure and then converts the data into structured form, for example, as JSON objects, before transmission.

The server receives the structured data via the network interface and passes it to a server-side application running on the processor. In one embodiment, the server-side application is implemented using a general-purpose programming language such as Python and a web framework such as a lightweight framework or a full-stack web framework. The server uses a JSON parsing library to decode the structured data into internal data objects. The server then executes validation logic, which verifies that required fields such as user identifier, activity type, at least one availability slot, and a location are present and properly formatted.

The server uses a storage device, such as a relational database system, to store the structured data. In one embodiment, the server employs a relational database engine, such as a generic SQL-based database, executing on separate hardware or as a managed database instance. The server defines database schemas that include, for example, a user table, an activity profile table, a schedule table, an opponent requirement table, and a match table. The server uses an SQL driver or an object-relational mapping library to issue SQL commands. The server inserts or updates records in the database so that each user's activity type, history, performance, opponent attributes, and normalized availability information are persistently stored with indexes optimized for subsequent searches.

The server normalizes date and time information into a common time representation. The server, for example, converts local times received from terminals operating in multiple time zones into a common reference time such as a coordinated universal time representation, stored in a format compatible with database indexing (for example, a timestamp field). The server also normalizes place information into standardized position information. The server can convert human-readable addresses into geographic coordinates using a geocoding module that may be implemented as an external service or an internal library, and may also map those coordinates to canonical facility identifiers. By normalizing date, time, and location, the server can use range indexes and spatial indexes provided by the database engine, which improves query performance when searching for overlapping availabilities and nearby locations.

The server then uses the normalized structured data to generate prompt sentences for a generative AI model. The generative AI model is, in one embodiment, a neural network-based language model implemented as a transformer architecture with multiple self-attention layers, feed-forward layers, and learned token embeddings. The model is trained on a corpus that includes at least structured descriptions of activity matching scenarios, user attributes, and temporal and spatial constraints. The server does not simply offload decision-making to the model in an abstract manner. Instead, the server constructs prompt sentences that encode the normalized database fields into a text format that the model can reliably interpret and align with the database schema.

The server, for example, generates a prompt sentence in the following form: “Given the following user: activity type: tennis; experience: 3 years; skill level: intermediate; availability: Nov. 15, 2023, from 15:00 to 17:00 at an indoor court in central city; desired opponent: intermediate level, similar experience, age 20-30; and the following candidate records: [summaries of candidate users'skill levels, availability windows, and locations], determine which candidate user IDs are suitable opponents that satisfy the time, place, and attribute constraints. Output only the candidate user IDs that best match the specified conditions.”

The server may also use another prompt sentence, such as:

“Based on the user's playable date, time, and place, and the required opponent attributes, describe the criteria for selecting matching opponents and identify which candidate users satisfy all of these criteria.”

The server inputs such prompt sentences to the generative AI model via a model interface.

The server implements the model interface using an inference engine library that executes the trained neural network on hardware such as a graphics processing unit or a specialized AI accelerator. The generative AI model internally performs tokenization of the prompt sentence, applies embedding matrices, and processes sequences of tokens through multiple attention heads and layers. The model computes attention scores that prioritize portions of the prompt related to time constraints, spatial constraints, and opponent attributes. The model's weights are updated during a prior training phase using a loss function such as cross-entropy between predicted token sequences and reference outputs. During inference in the deployed system, the model uses fixed, trained weights and generates output tokens representing, for example, user identifiers or structured recommendations for candidate opponents.

The server receives the model's output as text and parses it to extract explicit indicators of candidate user identifiers or ranking scores. The server converts the generated text back into structured form and stores the output in the same or a related information storage area in the database. In some embodiments, the server also records additional features such as the candidate ranking positions, textual justifications, or confidence measures inferred from the model outputs.

In parallel with the generative AI model processing, the server executes a database search using the normalized structured data. The server constructs SQL queries that search the schedule table and the opponent requirement table for records where availability intervals overlap the requesting user's availability interval. In one implementation, the server uses a condition such as (other_user_start_time<user_end_time) AND (other_user_end_time>user_start_time) to ensure temporal overlap. The server also applies location constraints using either exact matches of facility identifiers or spatial constraints based on geographic coordinates, such as locations within a specified distance radius.

The server further joins the schedule table with the user profile table and the opponent requirement table to ensure that opponent attributes are mutually compatible. For example, the server verifies that the requesting user's desired skill range includes the candidate user's skill level, and that the candidate user's desired opponent skill range includes the requesting user's skill level. The server may implement such compatibility checks either through SQL join conditions or through a hybrid approach whereby initial filtering is done via SQL and final compatibility checks are done in application logic. This combination of relational filtering and application-level rules forms a search control function that operates deterministically and efficiently on the normalized data.

The server then reconciles and integrates the candidate sets obtained from the generative AI model and from the database search. The server aligns candidate identifiers in the model output with user identifiers in the database search result set. The server selects candidates that are present in both sets or that satisfy composite conditions derived from both outputs, such as candidates that are highly ranked by the model and also satisfy strict temporal and spatial constraints in the database. The server applies explicit rules, for example, discarding any candidate whose normalized availability does not overlap exactly with the requested time window, even if the generative AI model recommends the candidate in text form. This reconciliation step ensures that model outputs cannot introduce inconsistencies that violate the hard constraints encoded in the normalized database records.

The server generates match candidate information for each selected candidate. The server retrieves detailed data from the user profile tables, including attributes such as skill level, history, performance, and associated activity metadata. The server also retrieves location information and transforms geographic coordinates or facility identifiers into human-readable descriptions suitable for presentation. The server then constructs data objects that include the activity type, date, start time, end time, location description, and opponent summary. The server transmits the match candidate information to the terminal as notification information. In one embodiment, the server uses push notification services or email delivery services to push alerts to the terminal. The terminal receives the notification via an operating system push manager or an email client. The terminal displays a message such as:

“A matching opponent has been found for your tennis schedule on Nov. 15, 2023, from 15:00 to 17:00 at the central indoor court. Opponent skill level: intermediate; experience: 3 years.”

The user can then open the application on the terminal, retrieve detailed match information from the server via an HTTPS request, and confirm or decline the proposed match.

This architecture yields technical improvements over systems that rely solely on either rule-based queries or unstructured generative outputs. By normalizing date and time information into a common time representation and location information into standardized position information, the server allows the database engine to take full advantage of indexing and query planning optimizations. This reduces query latency and CPU load when searching across large sets of users and schedules. By restricting the generative AI model to operate on prompt sentences derived directly from normalized, schema-aligned data, and by reconciling model outputs with database search results, the server prevents inconsistent or non-compliant matches and ensures that the model's generative capacity is used as a ranking and selection aid rather than as an opaque decision engine.

Because the server processes high-dimensional preference and availability data using both the generative AI model and the relational search control function, the system can explore a large combinatorial space of potential matches more efficiently than a purely human-driven or static-rule-driven system. The generative AI model, configured as a transformer network with attention mechanisms, can compute context-dependent similarity between users based on natural-language descriptions of attributes and histories that would be difficult to encode as simple numeric filters. However, the server constrains and post-processes those similarities using normalized and indexed database fields, which results in improved precision of the final match candidates and reduced false positives.

In one embodiment, the generative AI model is trained using supervised learning with training pairs consisting of prompt sentences encoding historical user data and target sequences encoding known successful match pairs or ranking orders. The server or an offline training system computes a loss function such as cross-entropy between the predicted opponent identifiers and the target identifiers. The training system updates the model weights using gradient-based optimization such as stochastic gradient descent or an adaptive variant. Data augmentation may be applied to training prompts by rephrasing attribute descriptions, permuting irrelevant segments, or adding controlled noise to numerical fields. This training regime teaches the model to map from structured, normalized representations plus descriptive text fragments to ranking decisions that reflect historical success patterns.

Because the server uses a hybrid approach in which the generative AI model suggests candidates within the structural boundaries enforced by the normalized database, the overall computer system gains robustness and efficiency. The processor does not simply automate a human mental process of “choosing an opponent”; instead, the processor reconfigures how data are represented, indexed, and fed into the model, and how model outputs are reconciled, to achieve technical effects: reduced search time for large user bases, improved cache and index utilization in the database, and decreased bandwidth in the communication between server and terminal by transmitting only filtered match candidate information rather than raw user lists.

The terminal also benefits from this architecture. Because the server pre-selects and ranks appropriate candidates using the combined model and database processing, the terminal does not need to download large unfiltered lists or execute complex matching logic locally. This reduces processing requirements and energy consumption on the terminal and lowers network traffic, enabling smoother user experience on resource-constrained devices.

Alternative embodiments are also possible. In one embodiment, the server executes the generative AI model locally on a dedicated AI accelerator card, while the relational database resides on a remote machine, with a high-speed internal network between the two. In another embodiment, the server calls a remote AI inference service, transmitting normalized prompt sentences and receiving outputs via an application programming interface, while still performing normalization, indexing, and reconciliation locally. Different model architectures may be used, such as recurrent neural networks or hybrid models combining convolutional and attention-based layers, provided that the model accepts text-form prompt sentences and outputs candidate-related information that can be mapped back to structured identifiers.

In yet another embodiment, the server augments the prompt sentences with additional features such as numeric embeddings of availability windows, discretized spatial regions, or encoded mismatch penalties for specific attribute differences. The server may, for example, include in the prompt a sentence such as:

“Prefer candidates within 5 kilometers of the specified court and with skill level difference not exceeding one category.”

By systematically encoding such constraints, the server ensures that the generative AI model operates under explicit technical conditions that are derived from normalized fields and that the final outcome of the system is tightly coupled to the underlying data structures and indexable attributes.

Through these configurations, the server, the terminal, and the user interactions collectively implement a concrete technical solution for opponent matchmaking that goes beyond generic data retrieval. The specific combination of normalization, indexed storage, structured prompt generation, neural network inference, and reconciliation logic improves the functioning of the computer system itself, including faster and more accurate retrieval of appropriate opponents, more efficient use of memory and processor resources, and improved reliability and consistency of match results across sessions and system loads.

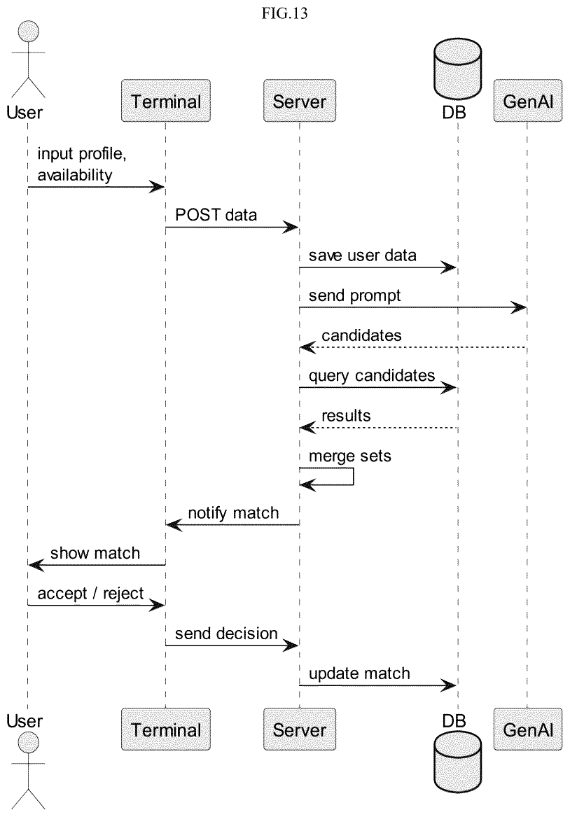

The following describes the processing flow using FIG. 13.

### Step 1:

The user operates the terminal to launch an application or open a web page that provides a matchmaking interface. The user inputs an activity type, past activity history, past performance, opponent attributes, and availability information including date, time, and place. The input of this step is raw user operations such as taps, text typing, and selection actions, and the output of this step is user-input data stored in UI components on the terminal.

### Step 2:

The terminal converts the user-input data into an internal structured representation, such as objects containing fields for activity type, history, performance, opponent attributes, and availability slots. The terminal validates the data by checking formats (for example, date and time patterns, numeric ranges) and required fields. The input of this step is the raw UI-level data, and the output is a validated in-memory data structure ready for serialization.

### Step 3:

The terminal serializes the in-memory data structure into a structured format, such as JSON, and attaches user identification and authentication tokens. The terminal builds an HTTPS request to the server, setting headers and embedding the JSON as the request body. The input of this step is the validated data structure, and the output is a network request message prepared for transmission.

### Step 4:

The terminal transmits the HTTPS request to the server through a communication network. The terminal uses a network stack and an HTTP client library to open a secure connection and send the serialized data. The input of this step is the prepared request message, and the output is a request delivered to the server's network interface.

### Step 5:

The server receives the HTTPS request through a network interface and passes it to a web application framework. The server reads HTTP headers to authenticate the user and extracts the JSON body. The input of this step is the raw HTTP request, and the output is parsed JSON data along with associated user context.

### Step 6:

The server parses the JSON data into internal objects using a JSON parsing library. The server performs server-side validation, checking that the activity type is supported, that the date and time fields are parseable, and that the opponent attributes conform to expected ranges or enumerations. The input of this step is the JSON text, and the output is validated server-side data objects containing normalized primitive values.

### Step 7:

The server normalizes date and time values into a common time representation, such as a unified timestamp based on a reference time standard. The server converts each local time received from the terminal using the user's time zone into a standard time zone, and then stores the result as a timestamp or standardized format. The input of this step is validated date and time strings, and the output is normalized time values suitable for indexed database storage and comparison operations.

### Step 8:

The server normalizes place information into standardized position information. The server converts textual addresses or facility names into geographic coordinates or facility identifiers using a geocoding component or lookup table. The input of this step is raw location descriptors, and the output is standardized position data that can be used in distance calculations and spatial database queries.

### Step 9:

The server constructs database records for the user profile, activity profile, schedules, and opponent requirements using the normalized time and location values and the user's attributes. The server uses an SQL driver to generate and execute INSERT or UPDATE statements that store the data into predefined tables in a relational database. The input of this step is normalized internal data objects, and the output is persistent records stored in tables indexed by user identifiers, timestamps, and position information.

### Step 10:

The server generates search conditions based on the stored user data, including the activity type, normalized availability window, standardized position, and opponent attributes. The server composes these conditions into query parameters suitable for both relational database search and generative AI model input. The input of this step is the normalized user data and database schema metadata, and the output is a set of structured search conditions that formally describe the desired match.

### Step 11:

The server generates a prompt sentence for a generative AI model by encoding the search conditions and optional candidate summaries into natural language or structured text. The server includes fields like activity type, time window, location description, and attribute constraints in the prompt. For example, the server creates text such as: “Given a user who wants to play tennis on Nov. 15, 2023, from 15:00 to 17:00 at an indoor court in the central area, with intermediate skill level and 3 years of experience, and who prefers opponents of intermediate level, similar experience, and age 20-30, select suitable opponents from the following candidates and output the most appropriate candidate user IDs.” The input of this step is the structured search conditions and candidate summaries (if available), and the output is a textual prompt sentence ready to be processed by the generative AI model.

### Step 12:

The server sends the prompt sentence to the generative AI model via an inference interface.

The server tokenizes the prompt if necessary, passes the token sequence to the model, and triggers forward propagation through the model's neural network layers. The input of this step is the prompt sentence, and the output is a sequence of generated tokens representing the model's response, which may include candidate user identifiers or a ranked list of candidates.

### Step 13:

The server decodes the generated token sequence from the generative AI model into text and parses the text to extract explicit candidate identifiers and any ranking or scoring information present. The server converts this parsed information into a structured format, such as a list of candidate IDs with associated scores. The input of this step is the generated token sequence, and the output is a machine-readable candidate list derived from the generative AI model.

### Step 14:

The server performs a database search independently of the generative AI model output. The server constructs SQL SELECT queries that use the previously generated search conditions to filter schedules, locations, and opponent requirements. The server executes the queries on the database engine, which uses indexes on time fields and position fields to efficiently retrieve matching records. The input of this step is the structured search conditions, and the output is a database-derived candidate set that satisfies hard constraints on availability, activity type, and mutual opponent attributes.

### Step 15:

The server reconciles and integrates the generative AI candidate set with the database-derived candidate set. The server compares candidate identifiers from both sets, computes intersections, and optionally applies additional rules such as minimum model score thresholds. The server discards candidates that do not satisfy database-enforced temporal or spatial constraints even if they appear in the model output. The input of this step is the model-derived candidate list and the database-derived candidate list, and the output is a final integrated candidate set that satisfies both learned preferences and strict data constraints.

### Step 16:

The server generates match candidate information for each candidate in the integrated set. The server retrieves detailed user profiles and schedule information from the database and formats them into concise summaries containing activity type, date, time, location, and key opponent attributes. The input of this step is the final integrated candidate set and stored profile records, and the output is a collection of match candidate objects that can be delivered to terminals.

### Step 17:

The server constructs notification messages from the match candidate objects. The server creates human-readable messages, such as “A suitable opponent has been found for your tennis session on Nov. 15, 2023, from 15:00 to 17:00 at the central indoor court. Opponent skill level: intermediate, experience: 3 years.” The input of this step is the match candidate objects, and the output is formatted notification payloads that can be transmitted via push notification or email.

### Step 18:

The server transmits the notification payloads to the terminals associated with the user and the selected opponents using a communication interface and external notification services. The server calls appropriate APIs to deliver the messages. The input of this step is the formatted notification payloads and terminal identifiers, and the output is notifications delivered to the terminals'operating systems or mailboxes.

### Step 19:

The terminal receives the notification from the push service or email system and displays the content on the screen. The terminal may show a banner or an alert with a short summary and provide a control that opens the application or a match detail screen. The input of this step is the incoming notification message, and the output is a visual presentation of the match proposal to the user.

### Step 20:

The user reviews the notification and opens the detailed match information on the terminal.

The user may confirm or reject the match using on-screen controls. The input of this step is the displayed notification and match details, and the output is user interaction data indicating acceptance, rejection, or a request for more information.

### Step 21:

The terminal sends the user's decision back to the server in a structured message over HTTPS. The message includes the match identifier and the decision flag (for example, confirmed or declined). The input of this step is the user's selection event, and the output is a confirmation or rejection request transmitted to the server.

### Step 22:

The server receives the decision request, updates the corresponding match record in the database to reflect the new status, and may trigger additional notifications to the other party to inform them of the decision. The input of this step is the user's decision message, and the output is updated match status data and, optionally, further notification payloads.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented matching systems for activities such as competitive play, collaborative work, or on-demand services generally rely on static, rule-based filtering over user profiles, availability data, and basic preference fields. In such systems, an information processing device typically executes database queries to identify counterpart candidates (for example, opponents, partners, or service providers) that satisfy simple constraints such as category, level, or time window. However, these architectures exhibit several technical shortcomings.

First, the server-side processing pipeline is not designed to integrate heterogeneous data types structured profile data, temporal availability data, spatial location data, and unstructured emotion-related data into a unified, machine-usable representation for candidate selection. As a result, the processor often executes multiple disjoint and sequential filtering operations, causing redundant data access, suboptimal cache locality, and increased latency in generating a final match result.

Second, conventional systems do not leverage generative artificial intelligence models in a structured and controllable manner within the server's core decision pipeline. When generative models are used at all, they are typically invoked only for peripheral tasks such as producing recommendation text, rather than being driven by programmatically constructed prompt sentences that encode machine-readable matching constraints. This means that the computational capabilities of generative models are not effectively harnessed to perform or refine candidate extraction and ranking, and the server cannot reliably incorporate model outputs into deterministic scoring and selection logic.

Third, most existing systems treat the user's emotional state as either unavailable or irrelevant for system-level computation. Emotion-related data, if present, may be used for simple user interface personalization, but is not fed into the scheduling logic or candidate selection algorithm at the server. Consequently, the processor does not adjust availability windows or ranking weights based on recognized emotional states or inferred activity energy levels. This leads to technically suboptimal scheduling and matching outcomes, where the system fails to optimize for user satisfaction and engagement in a reproducible, machine-controlled way.

Fourth, while geographic information services can provide distance and travel time data, conventional matching engines rarely integrate such data as first-class numerical features into a unified multi-factor scoring function executed server-side. Instead, distance constraints may be handled by coarse filters or client-side approximations, which increases inconsistency, network overhead, and computational burden on user terminals, and prevents the server from globally optimizing matches across a population of users and counterparts.

Accordingly, there is a need for an improved computer-implemented system in which the processor (i) constructs and maintains structured data that associates user history, counterpart conditions, availability information, and location information; (ii) programmatically generates prompt sentences encoding these structured data for submission to a generative artificial intelligence model; (iii) integrates outputs of an emotion recognition processing unit to estimate emotional states and activity energy levels of users and to algorithmically adjust availability time information; and (iv) combines generative model outputs, adjusted schedules, and geographic metrics into a unified, multi-criteria evaluation and selection pipeline. Such a system would reduce server-side processing inefficiencies, improve the quality and responsiveness of matching decisions, and provide a technically improved way of utilizing generative artificial intelligence and emotion recognition within a networked information processing architecture.

The specific processing by the specific processing unit 290 of the data processing device 12 in Application Example 2 is realized by the following means.

The present invention provides a server comprising a processor and a memory storing instructions that, when executed by the processor, cause the processor to provide, to a user terminal, a user interface through which a user inputs activity information including at least one of a type of competition or activity, past history information, condition information regarding a counterpart, availability time information, and place information; to store, in the memory as structured data, the activity information in association with the availability time information and the place information; to generate, on the basis of the structured data, a prompt sentence in the form of a text string that encodes search conditions for counterpart candidates and includes counterpart candidate data; to input the prompt sentence and the counterpart candidate data into a generative artificial intelligence model to cause the generative artificial intelligence model to execute extraction or ranking of the counterpart candidates; to input emotion-related information acquired from the user into an emotion recognition processing unit, to estimate, on the basis of an output of the emotion recognition processing unit, an emotional state and an activity energy level of the user, and to calculate adjusted availability time information by adjusting the availability time information of the user in accordance with the estimated emotional state and the activity energy level; to acquire geographic position information for the user and for the counterpart candidates, to obtain distance information or movement time information from a geographic information processing service on the basis of the geographic position information, and to calculate, for each counterpart candidate, an evaluation value using a plurality of evaluation indices including at least a condition suitability, a time suitability based on the adjusted availability time information, a distance index based on the distance information or the movement time information, and an emotion suitability based on the emotional state and the activity energy level; to specify an optimal counterpart on the basis of the evaluation value; and to generate and transmit, via a communication network, notification information including information regarding the specified counterpart and the adjusted availability time information to the user terminal and to a counterpart terminal. This enables the server to perform an integrated, computer-implemented matching operation in which structured profile, temporal, spatial, and emotional data are combined with outputs of a generative artificial intelligence model into a unified, multi-criteria scoring and selection pipeline, thereby improving server-side processing efficiency, reducing latency, and enhancing the technical quality and adaptability of counterpart matching and schedule determination.

The term “system” refers to an arrangement of one or more information processing devices, storage devices, communication interfaces, and user terminals that cooperate to execute the processing defined in the claims.

The term “processor” refers to one or more hardware logic elements, such as a central processing unit or a processing core, configured to execute instructions to perform the operations described in the claims.

The term “memory” refers to one or more storage media, such as volatile or non-volatile storage, configured to store instructions and data for use by the processor.

The term “user terminal” refers to an electronic apparatus operated by a user, such as a mobile terminal, a portable information device, or a personal computing device, that provides input and output functions for interaction with the system.

The term “counterpart terminal” refers to an electronic apparatus operated by a counterpart user, such as an opponent, partner, or service provider, that receives notification information from the system and participates in a matched activity.

The term “display device” refers to a visual output component, such as a screen or monitor, that presents graphical or textual information to a user of a user terminal or a counterpart terminal.

The term “input device” refers to a component that receives operation information from a user, such as a touch panel, keyboard, pointing device, microphone, or sensor interface.

The term “activity information” refers to information related to a target activity, including at least one of a type of competition, a type of non-competitive activity, or a type of service utilized for matching counterparts.

The term “competition” refers to an activity in which at least two participants engage in a contest or game according to rules, including but not limited to sports and electronic games.

The term “activity” refers to any user-participated event, task, or service use, including competitive activities, cooperative activities, and on-demand service interactions.

The term “past history information” refers to data representing a user's prior participation in activities or competitions, including records such as events, dates, performance metrics, or outcomes.

The term “condition information” refers to constraint data or preference data indicating requirements that a user specifies for a counterpart, including factors such as level, style, or attribute of the counterpart.

The term “counterpart candidate” refers to a potential participant, opponent, partner, or service provider that is considered as a candidate to be matched with a user for a specified activity.

The term “availability time information” refers to data that describes one or more time periods during which a user or a counterpart is able to participate in an activity.

The term “adjusted availability time information” refers to availability time information that has been modified by the processor on the basis of at least an estimated emotional state and an activity energy level of the user.

The term “place information” refers to data representing a location associated with an activity, including at least one of a geographic area, a facility, an address, or a coordinate.

The term “position information” refers to geographic location data, such as coordinates or location identifiers, acquired for a user or a counterpart for use in distance or movement time calculation.

The term “structured data” refers to data stored in a predetermined data model, such as records, fields, or entries in a relational storage structure, allowing indexed access and association among items.

The term “storage device” refers to a physical device, such as a disk drive, solid-state drive, or memory module, configured to retain structured data, program code, and other information.

The term “user interface” refers to a combination of display elements and input controls provided to a user on a display device, through which the user can input information and receive information from the system.

The term “prompt sentence” refers to a text string that encodes search conditions, context information, and instructions, which is supplied as input to a generative artificial intelligence model to cause the model to perform a specific operation.

The term “generative artificial intelligence model” refers to an automated information processing model, implemented by software executed on computing hardware, that generates output data such as text or structured values based on input including at least a prompt sentence.

The term “emotion-related information” refers to data indicative of a user's emotional state, including at least one of textual self-report, biometric information, voice characteristics, and facial expression information.

The term “emotion recognition processing unit” refers to a processing component, which may include one or more machine learning models or external services, configured to analyze emotion-related information and output an estimated emotional state.

The term “emotional state” refers to a classification or parameterized representation of a user's psychological condition, such as stress, nervousness, relaxation, excitement, or similar categories.

The term “activity energy level” refers to a parameter representing an estimated ability or inclination of a user to engage in an activity, derived from at least the emotional state and optionally from historical activity patterns.

The term “geographic information processing service” refers to an external or internal information processing function that provides geographic computation, including at least distance calculation, route estimation, or movement time estimation, based on position information.

The term “distance information” refers to a quantitative value representing a spatial separation between locations associated with a user and a counterpart, derived from position information.

The term “movement time information” refers to an estimated time required for travel between locations associated with a user and a counterpart, derived by the geographic information processing service.

The term “evaluation index” refers to a numerical or categorical measure used as a factor in the calculation of an evaluation value for a counterpart candidate.

The term “condition suitability” refers to an evaluation index that represents how well a counterpart candidate satisfies condition information specified by a user.

The term “time suitability” refers to an evaluation index that represents how well a counterpart candidate's available time corresponds to the adjusted availability time information of a user.

The term “distance index” refers to an evaluation index that represents a favorability of spatial separation or movement time between a user and a counterpart candidate.

The term “emotion suitability” refers to an evaluation index that represents compatibility between a user's emotional state and activity energy level and attributes of a counterpart candidate or an activity context.

The term “evaluation value” refers to a composite score or rating for a counterpart candidate, calculated by combining multiple evaluation indices according to a predetermined algorithm.

The term “optimal counterpart” refers to a counterpart candidate that is selected by the processor as best suited for a user according to the evaluation value and the criteria defined by the system.

The term “notification information” refers to data generated by the processor that includes at least identification information for a specified counterpart and time-related information, and that is transmitted to a user terminal or a counterpart terminal.

The term “communication network” refers to a wired or wireless data communication infrastructure that enables data exchange between the server, user terminals, counterpart terminals, and external services.

The term “extraction” refers to a process in which one or more counterpart candidates are selected or filtered from a set of candidates according to specified conditions.

The term “ranking” refers to a process in which counterpart candidates are arranged in an ordered list based on one or more criteria, such as scores or evaluation values.

The term “selection reason” refers to an explanation or justification output by a generative artificial intelligence model or the processor, indicating why a particular counterpart candidate has been chosen as an optimal counterpart.

The term “proposed time” refers to a time or time period suggested by the system or by a generative artificial intelligence model as appropriate for execution of an activity between a user and a counterpart.

The term “counterpart candidate identifier” refers to data, such as a unique identifier or key, that enables the system to uniquely refer to a specific counterpart candidate within stored structured data.

In an embodiment, a server cooperates with one or more terminals operated by users and counterparts to implement the claimed system. The server includes at least one processor, a main memory, a non-volatile storage device, and a network interface. The processor executes software components including a web application module, an application programming interface (API) module, a matching engine module, an emotion recognition interface module, a generative artificial intelligence interface module, and a geographic information interface module.

A terminal includes a display device, an input device, a communication module, and optionally a location sensor and biometric sensors. The terminal runs client software, such as a web browser or a native application, to display graphical user interfaces and to send and receive structured data to and from the server via a communication network.

A user operates the terminal to access the system. The user uses the terminal to input activity information, past history information, condition information for a counterpart, availability time information, and place information. The user also optionally inputs emotion-related information, such as a self-description of mood in text, and may allow the terminal to capture biometric signals such as heart rate or facial images.

A server uses a relational database management system, such as a general-purpose relational database executing on the server, to store structured data including user profiles, history records, counterpart records, schedule records, emotion records, and geographic data. The server defines tables with fields for user identifiers, activity types, history metrics, counterpart conditions, availability time ranges, position coordinates, and emotion labels.

A server uses an emotion recognition processing unit implemented as a combination of software and hardware that can reside on the same machine as the server or on a separate machine. The emotion recognition processing unit includes at least one neural network model for text-based emotion recognition and, optionally, at least one neural network model for biometric-based emotion recognition. The text-based model is, for example, a transformer-based neural network having multiple self-attention layers, trained on labeled corpora of text annotated with emotion categories such as “relaxed,” “nervous,” “excited,” and “depressed.”

The biometric-based model is, for example, a convolutional neural network for facial expression classification or a recurrent neural network for heart-rate sequence analysis.

A server uses a generative artificial intelligence model deployed on an AI processing platform. The generative artificial intelligence model is, for example, an autoregressive transformer neural network with multiple encoder-decoder layers, multi-head self-attention mechanisms, and a large parameter count. The model is trained on a corpus of text including examples of matching scenarios, schedule suggestions, and explanation texts. The model is configured to accept a prompt sentence, which is a natural-language text sequence that encodes structured activity, history, condition, schedule, and counterpart candidate data, and to output a natural-language response that may include selected candidate identifiers, ranking rationales, and proposed times.

A server uses a geographic information processing service, which may be implemented as an external map service, to calculate distance information or movement time information from position information of the user and the counterpart candidates. The geographic information processing service receives coordinates and returns numeric distance values and estimated travel times.

A server implements data processing and data computation that combine these components in a technical manner. The server first represents user activity information, history information, condition information, and availability time information as structured data, such as relational records with normalized fields. The server associates these records with place information stored as geographic coordinates. This structure enables indexed access and efficient join operations, which reduce the number of database scans and improve cache locality when the matching engine reads multiple related tables.

A server uses algorithmic feature extraction to convert structured and unstructured data into feature vectors used in the matching engine. For example, the server maps categorical activity types and levels to integer indices and then to dense embeddings. The server converts availability time ranges into normalized numeric time-slot indicators. The server converts distance information or movement time information into scalar features. The server converts emotion labels and activity energy levels into one-hot or multi-hot vectors. The server composes these features into feature vectors that are input to a scoring function.

A server implements a scoring function that calculates an evaluation value for each counterpart candidate. The server uses a weighted sum or other numerical composition of multiple evaluation indices, such as condition suitability, time suitability, distance index, and emotion suitability. For instance, the server calculates condition suitability by comparing the user-specified counterpart conditions to attributes stored in the counterpart records. The server calculates time suitability by computing the overlap between adjusted availability time information of the user and availability ranges of the candidates. The server calculates the distance index by mapping geographical distance or movement time to a score using a monotonically decreasing function. The server calculates emotion suitability by applying pre-defined compatibility rules between emotional states and counterpart types, such as assigning higher scores to calm counterparts when the user is nervous.

A server integrates the generative artificial intelligence model into this technical pipeline by constructing prompt sentences that encode structured data in a deterministic and machine-readable manner. For example, a server generates a prompt sentence such as:

“Given a user with the following profile: sport=tennis, level=intermediate, available time=weekend afternoon, emotional state=nervous, activity energy level=medium. Given the following candidate opponents with IDs, levels, available times, and distances: [list]. Select the best opponent ID and explain briefly.”

A server includes in the prompt sentence both human-understandable descriptions and machine-originated identifiers that can be parsed from the model output. The server instructs the model to return a formatted response that contains explicit identifiers and proposed times.

The server then parses the response to extract the selected candidate identifier and any proposed time values, and uses these values to refine or override preliminary ranking computed by the rule-based scoring function. This hybrid approach exploits the generative model's capacity for multi-factor reasoning while maintaining deterministic control over how the outputs are integrated.

A server calculates adjusted availability time information by using the output of the emotion recognition processing unit. For example, the server receives from the emotion recognition processing unit an emotional state label “excited” and an activity energy level “high.” The server then executes an adjustment algorithm that shifts a user's originally selected time slot from 15:00-17:00 to 16:00-18:00 based on rules that associate high energy levels with later or extended activity windows. The server stores both the original and adjusted time ranges, and uses the adjusted time ranges for time suitability calculations. This algorithmic adjustment is implemented as a deterministic function, such as adding or subtracting offsets, scaling duration, or selecting from a set of pre-defined alternative time windows.

A server obtains technical benefits from this architecture. By performing emotion-based schedule adjustment and distance-based scoring within the server-side matching engine, the server avoids redundant client-side filtering and reduces the number of network round trips.

By structuring the data and performing feature extraction on the server, the system reduces CPU cache misses and index traversal overhead compared to naive, unstructured string-based filtering. By using a hybrid rule-based and generative-model-based candidate selection approach, the server improves matching precision compared to purely rule-based or purely generative approaches, because the rule-based layer enforces hard constraints and the generative layer refines ranking and explanations within those constraints.

A server improves computational efficiency of the generative artificial intelligence model integration by constructing concise prompt sentences that include only essential identifiers and summarized feature values. The server omits redundant text, thereby reducing the length of the input sequence, the number of attention computations inside the transformer architecture, and thus inference latency. The server further improves accuracy by explicitly encoding emotional state and activity energy level in the prompt sentence, which guides the model to consider these factors when selecting candidates.

A server can implement alternative embodiments to adapt the architecture to different deployment environments. In one embodiment, the server executes all core components on a single physical machine in a data center, and accesses an external generative artificial intelligence service and an external geographic information processing service via secure APIs. In another embodiment, the server distributes the matching engine and the emotion recognition processing unit across multiple machines and employs a message queue system to transfer feature vectors between modules. In yet another embodiment, the server deploys a smaller generative active model locally to reduce network latency while using a larger model remotely for batch optimization of matching parameters.

A terminal participates in the technical process by acquiring sensor data and presenting results with minimal overhead. For instance, a terminal acquires position information through the device's location subsystem, formats the coordinates as numeric values, and includes them in a structured payload sent to the server. A terminal may capture a facial image using a camera, apply on-device compression, and upload a reduced-resolution image to the server, thus reducing network bandwidth. A terminal displays only the final selected counterpart and the adjusted time information, avoiding repeated intermediate updates and therefore reducing communication traffic.

A user benefits from the resulting improved matching quality and responsiveness. The user sees that the system proposes counterparts and times that better match the user's emotional state and practical constraints, even when the user only provides simple textual emotional descriptions. The user is not required to understand the internal scoring mechanisms; the server and the associated processing modules perform all numerical computation and reasoning.

A server can implement different emotion recognition models and training methods. For text-based emotion recognition, the server uses a transformer encoder trained with supervised learning. The server defines an objective function such as cross-entropy loss between predicted emotion label distributions and ground-truth labels. The server updates the model parameters using gradient descent with backpropagation. The server can augment training data with paraphrasing and synonym substitution to improve robustness to varied user expressions. For biometric-based recognition, the server trains convolutional neural networks using facial images labeled with emotions, and uses a softmax output layer to generate probabilities over emotion classes.

A server can also adapt the generative artificial intelligence model to the matching domain through fine-tuning. The server constructs training examples in which prompt sentences describe user profiles, candidate lists, and emotion states, and output sequences describe selected candidate identifiers and rationales. The server uses a language modeling objective, minimizing negative log-likelihood of target tokens given prompt tokens and intermediate tokens. The server periodically re-trains or updates the model with new matching outcomes and user feedback to improve selection quality.

A server differs from mere human task automation by implementing non-conventional, machine-oriented rules that leverage the structure of the transformer architecture and the multi-factor evaluation algorithm. For example, the server defines prompt sentence templates that include machine identifiers, numeric features, and explicit instructions for constrained output formats. This design allows the server to parse the model output reliably and to combine it with numeric scores. Human operators would not naturally follow such strict formatting conventions when reasoning about matches. The system therefore achieves a more integrated and computationally exploitable pipeline than a simple automation of human decision-making.

A server enhances data management by structuring all activity, emotion, and geographic data in normalized tables with foreign keys and indexes. This allows the server to execute join operations across history, emotion, and schedule tables using optimized query plans. The server thus reduces I/O operations required to assemble candidate data sets compared to storing all data in unstructured logs.

A server can include fallback and variant mechanisms. In one variant, when the generative artificial intelligence model is unavailable or returns an ambiguous response, the server relies solely on the rule-based evaluation indices and scoring function to select an optimal counterpart. In another variant, the server uses the generative model only to propose adjustments to time windows, while selection among candidates is fully numeric. In yet another variant, the server uses multiple generative models, one specialized for scheduling and another for counterpart attribute reasoning, and combines the outputs through the scoring function.

A server thereby implements a concrete technical solution: the server reduces end-to-end latency in matching, improves matching accuracy by integrating emotion and geographic features, reduces communication overhead by concentrating computation on the server, and uses a generative artificial intelligence model within a controlled, prompt-based framework that is integrated into a deterministic evaluation function. The combination of structured data management, feature-based scoring, emotion recognition, geographic computation, and prompt-driven generative processing yields a technical improvement to computer-based matching systems beyond generic data retrieval or simple business-rule automation.

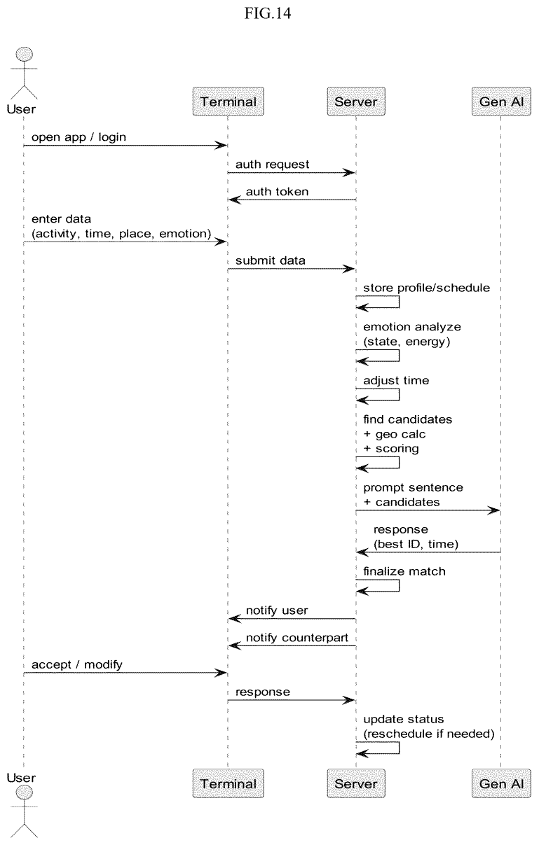

The following describes the processing flow using FIG. 14.

### Step 1:

User operates the terminal to launch an application and to authenticate.

User inputs identification information, such as an email address and a password, into a login screen displayed on the terminal and triggers a login operation.

Terminal takes, as input, the identification information and generates a structured request including user credentials. Terminal transmits this request to the server over a communication network.

Server receives, as input, the user credentials, executes a database query against a user table to retrieve a stored password hash, and applies a cryptographic verification algorithm to compare the hash with the received password. Server outputs an authentication result and, when authentication succeeds, generates a session token as a data string. Server returns the session token to the terminal.

Terminal stores the session token in a secure local storage area and outputs an authenticated state to the user interface, enabling access to further functions.

### Step 2:

User operates the terminal to input activity information, history information, and condition information for a counterpart.

User selects, on the terminal display, at least one activity or competition type, such as a sport or a service category, and inputs past history information, such as performance records or prior participation data, and condition information for a desired counterpart, such as skill level or behavioral preferences.

Terminal takes, as input, the user's selections and text entries and converts them into structured fields, for example activity_type, history_summary, and counterpart_conditions.

Terminal generates a JSON or similar structured object and transmits this object to the server together with the session token.

Server receives, as input, the structured activity, history, and condition information. Server parses the object, validates data types and required fields, and writes the values into corresponding columns of one or more database tables, such as a user_profile table and a counterpart_condition table. Server performs data processing in the form of relational INSERT or UPDATE operations and outputs stored records that can be indexed and retrieved by subsequent queries.

### Step 3:

User operates the terminal to input availability time information and place information.

User selects or edits one or more time periods during which the user is available for an activity and optionally specifies a place, such as a venue or a region, using calendar widgets and map controls on the terminal.

Terminal takes, as input, the selected dates, times, and location description. Terminal converts date and time into normalized timestamps or time-interval representations and converts the place description into coordinates by invoking a local or remote geocoding function, when available. Terminal outputs a structured data object that includes availability ranges and position information and transmits this object to the server.

Server receives, as input, the availability time ranges and the place coordinates. Server stores these values in schedule and location tables, performing data processing that includes normalization of time intervals and indexing of coordinates. Server outputs persistent records associating user identifiers with availability windows and place information.

### Step 4:

User optionally operates the terminal to input emotion-related information.

User types a free-text description of mood, such as “I feel nervous today,” into an emotion input field and may enable camera or sensor functions to capture facial images or heart-rate signals.

Terminal takes, as input, the emotion text and any captured biometric data. Terminal formats the emotion text as a character string and compresses biometric data, such as images or time-series samples, into binary or numeric arrays. Terminal outputs an emotion payload containing text and sensor data and transmits this payload to the server.

Server receives, as input, the emotion payload and stores raw emotion text and biometric samples in an emotion_raw table. Server outputs stored identifiers that link raw emotion data to the user profile for further processing.

### Step 5:

Server processes emotion-related information using an emotion recognition processing unit.

Server takes, as input, the emotion text and biometric data identifiers from the emotion_raw table. Server sends the text to a text-based emotion recognition model and sends biometric features, such as face image pixels or heart-rate sequences, to a biometric-based emotion recognition model. Each model is a trained neural network that computes intermediate activations and final class probabilities.

Server performs data computation in the form of forward passes through multi-layer networks: for text, tokenization, embedding, self-attention, and classification layers; for biometrics, convolution or recurrent layers and classification layers. Server aggregates outputs to estimate an emotional state label, such as “nervous” or “excited,” and an activity energy level, such as “medium” or “high,” using a rule engine or a small combining network.

Server outputs, as results, an emotional_state value and an energy_level value and stores these values in an emotion_state table keyed by user identifier and timestamp.

### Step 6:

Server adjusts availability time information based on emotional state and activity energy level.

Server takes, as input, original availability time ranges from the schedule table and the emotional_state and energy_level values from the emotion_state table. Server applies an adjustment algorithm that uses predefined rules, such as shifting or scaling time ranges when the energy_level is “high” or “low.”

Server performs data computation by mapping each original time interval to an adjusted interval. For example, server adds a fixed offset or changes duration according to a rule set encoded as parameters. Server outputs adjusted time ranges, referred to as adjusted availability time information, and writes the adjusted ranges into an adjusted_schedule table that maintains a link to the original ranges.

### Step 7:

Server retrieves counterpart candidates and computes basic suitability features.

Server takes, as input, the user's activity type, history, counterpart_conditions, adjusted availability time information, and place information from the database. Server constructs a set of database queries to retrieve counterpart candidates whose activity type matches and whose own availability ranges overlap with the adjusted availability time information.

Server performs data processing by executing relational SELECT queries with conditions on activity type, level, and time overlap. Server obtains a candidate set and, for each candidate, retrieves associated profile records, schedule records, and position information. Server outputs an in-memory candidate list with attributes such as skill level, availability slots, ratings, and coordinates.

Server converts categorical and numeric attributes into feature values, such as integer-coded levels and normalized time-slot vectors, and outputs a feature matrix representing candidates for further scoring.

### Step 8:

Server calculates geographic distance and movement time for counterpart candidates. Server takes, as input, position coordinates of the user and each candidate from the candidate list. Server calls a geographic information processing service, sending pairs of coordinates. The service returns distance and movement time for each pair.

Server performs data computation by normalizing distances and times into distance indices, for example by applying a decreasing function that maps larger distances to smaller scores.

Server outputs updated candidate features that now include distance and movement time values and corresponding distance indices.

### Step 9:

Server computes evaluation indices and preliminary evaluation values for counterpart candidates.

Server takes, as input, candidate feature vectors, user counterpart_conditions, adjusted availability time information, and emotional_state and energy_level values. Server computes condition suitability by comparing candidate attributes with counterpart_conditions using rule-based matching, such as equality checks and threshold tests.

Server computes time suitability by calculating numeric overlap between candidate availability ranges and the adjusted availability time information. Server computes emotion suitability by applying compatibility rules that relate emotional_state and energy_level to candidate attributes, such as preferring calm candidates when emotional_state is “nervous.”

Server uses these indices, along with the distance index, to compute an evaluation value for each candidate by applying a weighted combination, such as a weighted sum. The input features and weights are combined using vector multiplications and additions. Server outputs a preliminary ranked list of candidates sorted by evaluation value.

### Step 10:

Server generates a prompt sentence for a generative AI model and invokes the model.

Server takes, as input, the user's activity type, history summary, counterpart_conditions, emotional_state, energy_level, adjusted availability time information, and the preliminary candidate list with identifiers and features. Server constructs a prompt sentence by inserting these values into a template in natural language.

Server performs data processing by concatenating strings representing user profile, constraints, and candidate descriptions into a single text. For example, server may generate a prompt sentence such as:

“Given a user with sport=tennis, level=intermediate, available time=weekend afternoon (adjusted), emotional state=nervous, activity energy level=medium, and the following candidates with IDs, levels, times, and distances, choose the best opponent ID and explain briefly.”

Server sends this prompt sentence as input to a generative AI model endpoint and receives, as output, a response text that includes at least one candidate identifier and possibly a proposed time and justification text.

### Step 11:

Server parses the generative AI model response and refines candidate selection.

Server takes, as input, the response text from the generative AI model and the preliminary ranked candidate list. Server performs text parsing, using pattern matching or explicit marker tokens, to extract a selected candidate identifier and any proposed time adjustments mentioned in the response.

Server compares the selected candidate identifier to the preliminary ranking and, when consistent, confirms the candidate as optimal. When a discrepancy exists, server may adjust the evaluation value of the selected candidate by increasing its score by a fixed factor or re-ranking using a hybrid rule. Server thus performs data computation that fuses numeric evaluation values and textual model output. Server outputs a final selected optimal counterpart and, when applicable, an updated proposed activity time.

### Step 12:

Server generates notification information and transmits it to the terminals.

Server takes, as input, the final selected counterpart identifier, the adjusted availability time information or proposed time, and user and counterpart terminal identifiers. Server retrieves displayable names and details from the database and constructs notification content that contains counterpart identity and scheduled time.

Server performs data processing by encapsulating the notification content into message payloads compatible with a push notification service or a messaging protocol. Server outputs notification payloads and transmits them through the communication network to the terminals of the user and the counterpart.

### Step 13:

Terminal receives notification information and presents it to the user.

Terminal takes, as input, the notification payloads received from the server via a push notification service or a direct API call. Terminal decodes the payload, extracts counterpart details and schedule information, and maps any internal identifiers to user-friendly text. Terminal performs data processing by updating user interface state, such as constructing a screen that displays the counterpart's level, approximate distance, and the scheduled time.

Terminal outputs a visual notification or a dedicated screen, enabling the user to confirm or reject the proposal.

### Step 14:

User operates the terminal to respond to the proposed counterpart and time.

User reviews the displayed information and selects an action, such as accepting, declining, or modifying the proposed time. User may enter an alternative time or a comment.

Terminal takes, as input, the user's selection and any new time values, formats them into a structured response including status and optional modified time, and transmits this response to the server. Terminal outputs a confirmation message locally that the response has been sent.

### Step 15:

Server updates matching status and, when necessary, re-computes schedule or candidate selection.

Server takes, as input, the response from the terminal, including status (accepted, declined, or modified) and any updated time information. Server writes this status to a matching_status table and, for an accepted match, records a confirmed schedule entry.

Server performs data computation by verifying whether a modified time conflicts with other commitments, and, if necessary, re-executing parts of the evaluation and selection algorithm or generating a new prompt sentence to the generative AI model to resolve conflicts. Server outputs updated status records and, when required, follow-up notification payloads to be sent to the terminals of both the user and the counterpart.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

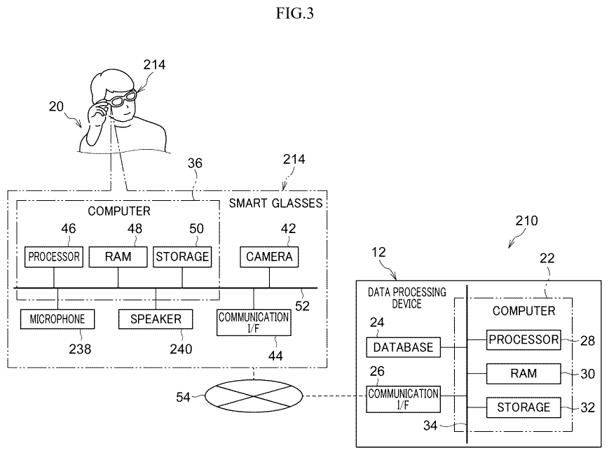

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

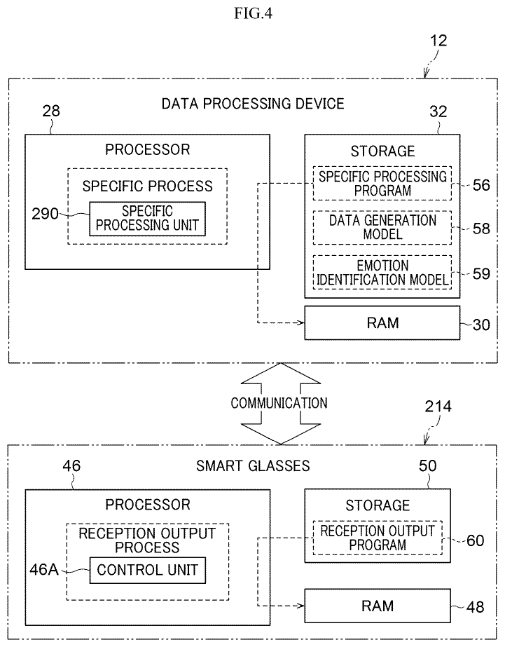

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

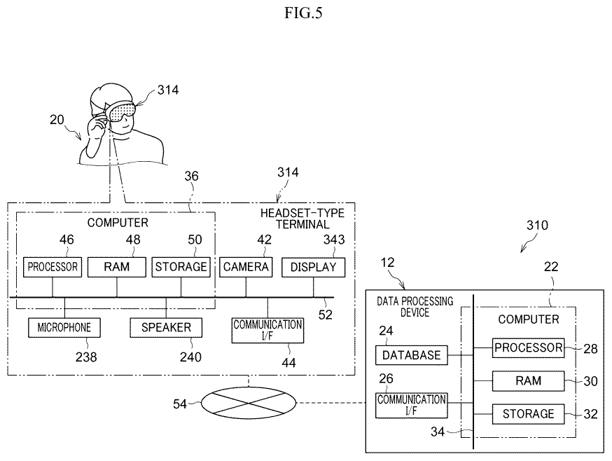

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

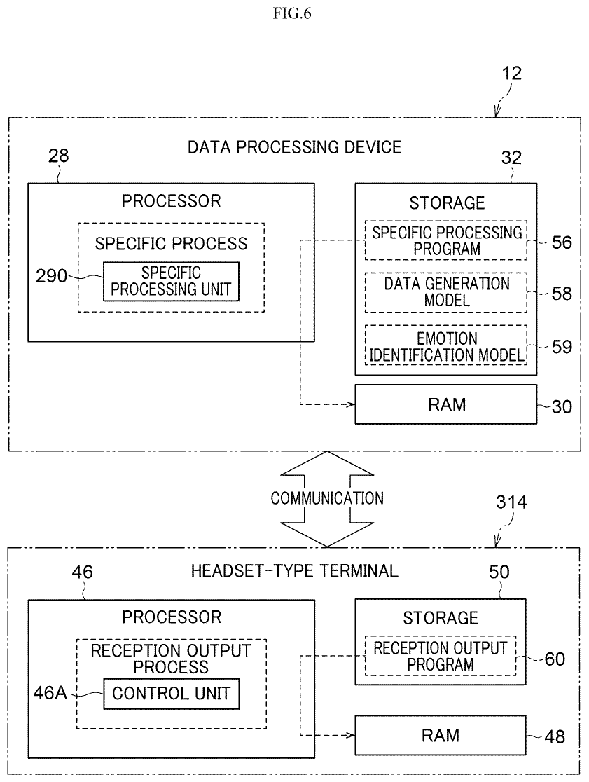

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

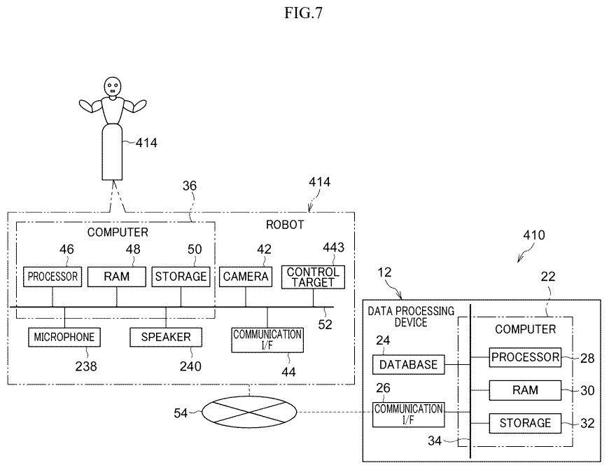

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

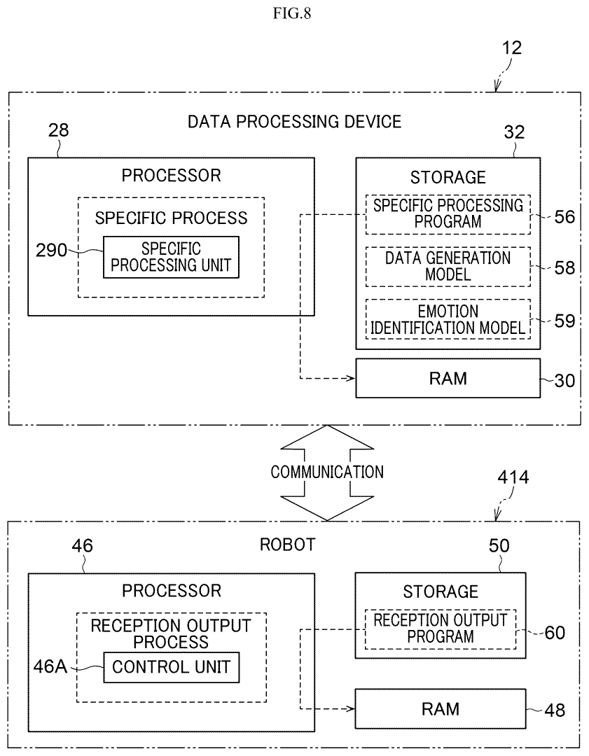

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

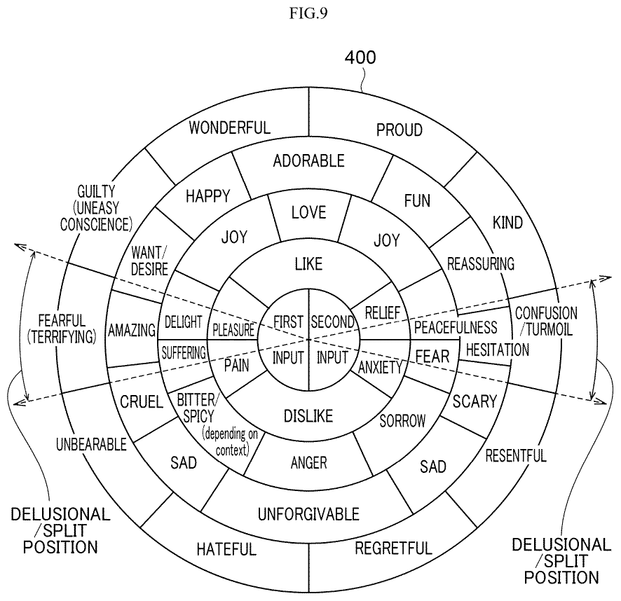

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

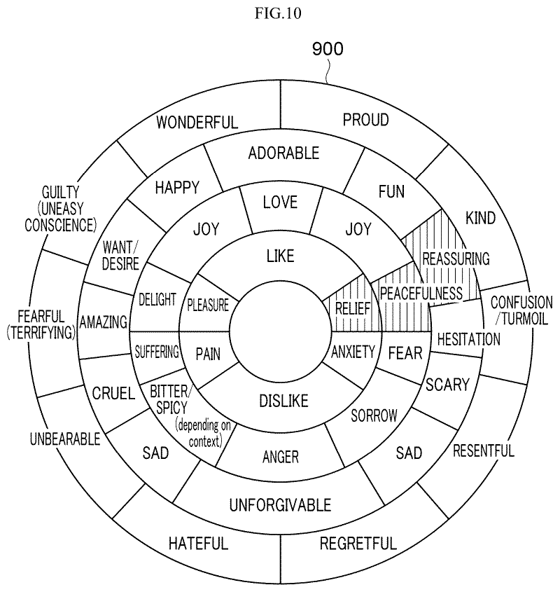

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
provide, to a user via a communication terminal executing a browsing program, a screen that constitutes a user interface for receiving input of a competition category, past activity history, activity results, desired opponent attributes, and available time from the user,
receive input information transmitted from the screen via a communication unit and register or update the input information in a structured information storage unit by using a query language,
generate a prompt sentence including selection conditions for candidate opponents on the basis of the input information of the user and attribute information of other participants stored in the structured information storage unit,
input the generated prompt sentence into a generative AI model, determine, on the basis of a response obtained from the generative AI model, selection conditions or a selection procedure for extracting candidate opponents, and search, in accordance with the determined selection conditions or selection procedure, the structured information storage unit for a set of candidate opponents that satisfy conditions of the user,
calculate, for the searched set of candidate opponents, a degree of compatibility between a skill level, an activity result, desired attributes, available time, and place-of-activity information of the user and corresponding information of each candidate opponent, and rank the candidate opponents on the basis of the degree of compatibility, and
generate display information including attribute information and activity history information of the ranked candidate opponents and generate screen data for causing the browsing program of the communication terminal to display the display information.

### (Supplementary 2)

The system according to supplementary 1,
wherein the processor is configured to
cause the user interface to provide, when the user inputs the available time, an input field for place-of-activity information, store the place-of-activity information in association with attribute information of the user and attribute information of the candidate opponents in the structured information storage unit, and further control a search process so as to narrow down the set of candidate opponents on the basis of an overlap between the place-of-activity information and the available time.

### (Supplementary 3)

The system according to supplementary 1,
wherein the processor is configured to
cause the user interface to provide a screen for receiving input of play style, skill characteristics, or other attributes desired for an opponent from the user, store the input attribute information in the structured information storage unit, input a prompt sentence including the attribute information into the generative AI model to update extraction criteria for the candidate opponents, and control the search process so as to search for the set of candidate opponents on the basis of the updated extraction criteria.

### Application Example 1

### (Supplementary 1)

A system comprising a processor,
wherein the processor is configured to
present, to a user, an information input/output screen that accepts input of a competition type, past competition history, performance information, and capability conditions required for an opponent,
store user input information acquired via the information input/output screen as structured data in an information storage area of a storage device, and acquire, from the information storage area, search target information for extracting candidate opponents based on the competition type, the capability conditions, and the performance information,
generate a prompt sentence that presents, to a machine learning processing apparatus, a candidate set including the candidate opponents by using the acquired search target information, and input the prompt sentence and the candidate set to a generative AI model in order to cause the generative AI model to evaluate and rank the candidate opponents in the candidate set, and
determine, based on an evaluation result output from the generative AI model, one or more of the candidate opponents as recommended opponents in ranked order, and transmit information regarding the recommended opponents to an information terminal of the user for presentation.

### (Supplementary 2)

The system according to supplementary 1,
wherein the processor is configured to
present, to the user, an information input/output screen that accepts input of an available time period and desired location information of the user, store the available time period and the desired location information in the information storage area, and include the available time period and the desired location information in the prompt sentence as evaluation conditions for the generative AI model when evaluating the candidate opponents.

### (Supplementary 3)

The system according to supplementary 1,
wherein the processor is configured to
present, to the user, an information input/output screen that accepts input of the capability conditions, regional conditions, and play-style conditions required for the opponent, extract the candidate set from the information storage area based on the capability conditions, the regional conditions, and the play-style conditions, and generate the prompt sentence including the conditions and input the prompt sentence to the generative AI model in order to cause the generative AI model to select candidate opponents satisfying the conditions and to generate explanatory information regarding the selected candidate opponents.

### EXAMPLE 2

### (Supplementary 1)

A system comprising a processor,
wherein the processor is configured to
provide, by using a display device and an input device, a user interface that allows a user to input information including a type of activity, past activity history, past performance, attributes required of an opponent, and date, time, and place at which the user is available to perform the activity,
convert input information acquired through the user interface into structured data, and store the structured data in an information storage area of a storage device by using a communication function,
generate, on the basis of input information stored in the storage device, search conditions corresponding to the date, time, and place at which the user is available to perform the activity and to the attributes required of the opponent, and create a prompt sentence including the search conditions so as to instruct an opponent candidate search process,
input the prompt sentence created as the prompt sentence into a generative information processing model, acquire output information regarding opponent candidates output from the generative information processing model, store the output information in the information storage area, and further present information regarding the opponent candidates to the user on the basis of the output information,
execute, by using a search control function, a search process on a plurality of pieces of user input information stored in the information storage area, and extract opponent candidates by determining whether another user is available to perform the activity at the date, time, and place at which the user is available to perform the activity and whether attributes required of the opponent are mutually compatible between the user and the other user, and
generate, for each extracted opponent candidate, match candidate information on the basis of an attribute of the opponent candidate, a kind of the activity, and the date, time, and place, and transmit the match candidate information as notification information to a terminal device, wherein the system comprises the display device, the input device, the storage device, and the terminal device.

### (Supplementary 2)

The system according to supplementary 1,
wherein the processor is configured to
normalize date and time information included in the structured data received from the terminal device into a common time representation, convert place information included in the structured data into standardized position information, store the normalized date and time information and the standardized position information in the information storage area, and execute the search process by using the normalized date and time information and the standardized position information.

### (Supplementary 3)

The system according to supplementary 1,
wherein the processor is configured to
compare the output information regarding the opponent candidates acquired from the generative information processing model with search results regarding opponent candidates acquired from the information storage area by the search process, and select, as the match candidate information to be notified to the terminal device, only opponent candidates that are common to both the output information and the search results or that satisfy conditions of both the output information and the search results.

### Application Example 2

### (Supplementary 1)

A system comprising a processor,
wherein the processor is configured to
provide, to a display device of a user terminal, a user interface that allows a user to input activity information including at least one of a type of competition or activity, past history information, and condition information regarding a counterpart for competition or participation, and to acquire input data related to the history information and the condition information from an input device of the user terminal,
store the input data, availability time information of the user, and place information of the user in association with each other as structured data in a storage device,
generate, on the basis of the structured data, a prompt sentence in the form of a text string that represents search conditions for counterpart candidates for the desired competition or activity, and input the prompt sentence and counterpart candidate data included in the structured data into a generative artificial intelligence model so as to cause the generative artificial intelligence model to perform extraction or ranking of the counterpart candidates,
input emotion-related information acquired from the user into an emotion recognition processing unit, estimate an emotional state and an activity energy level of the user on the basis of an output of the emotion recognition processing unit, and calculate adjusted availability time information by adjusting the availability time information of the user on the basis of the estimated emotional state and the activity energy level,
calculate, on the basis of a result of the extraction or the ranking of the counterpart candidates obtained from the generative artificial intelligence model, the adjusted availability time information, and geographic location information, an evaluation value for each counterpart candidate using a plurality of evaluation indices including at least a condition suitability, a time suitability, a distance index, and an emotion suitability, and specify an optimal counterpart for competition or participation on the basis of the evaluation value, and
generate notification information including information on the specified counterpart and the adjusted availability time information, and transmit the notification information via a communication network to the user terminal and to a counterpart terminal used by the specified counterpart.

### (Supplementary 2)

The system according to Supplementary 1,
wherein the processor is configured to acquire, when the user inputs an available schedule of the user, position information and facility information related to a use place from the input device of the user terminal, to acquire distance information or movement time information from a geographic information processing service by using the position information, and to use the distance information or the movement time information in calculation of the evaluation value for each counterpart candidate.

### (Supplementary 3)

The system according to Supplementary 1,
wherein the processor is configured to generate, as the prompt sentence to be input to the generative artificial intelligence model, an explanatory text including at least the history information of the user, the condition information, the emotional state, the activity energy level, and the counterpart candidate data, to cause the generative artificial intelligence model to generate, for the explanatory text, a response including at least a selection reason for an optimal counterpart candidate and a proposed time, and to extract a counterpart candidate identifier and time information from the response and reflect the counterpart candidate identifier and the time information in the specifying of the optimal counterpart and in the adjusted availability time information.

What is claimed is:

1. A system comprising:
circuitry configured to:
receive, via a communication interface coupled to a packet-switched network, structured input data from a terminal device, and store the structured input data in a storage device, the structured input data comprising activity category data, history record data, performance data, and attribute preference data associated with a user;
retrieve, from the storage device, participant attribute data corresponding to the activity category data, and generate a prompt sentence that encodes the structured input data and the participant attribute data as selection conditions for candidate identification;
supply the prompt sentence to a generative neural network model and extract, from output of the generative neural network model, machine-usable selection conditions for querying the storage device;
execute a structured query against the storage device using the machine-usable selection conditions to obtain a candidate set comprising a plurality of candidate records;
compute, for each candidate record in the candidate set, a compatibility score based on a multi-dimensional comparison between the performance data and the attribute preference data of the user and corresponding fields of the candidate record; and
rank the candidate records according to the compatibility scores, generate display data comprising attribute information and history record data for the ranked candidate records, and transmit the display data to the terminal device via the communication interface.

2. The system according to claim 1, wherein the circuitry is configured to normalize time availability data and position data included in the structured input data into a common time representation and standardized position coordinates prior to storing the structured input data in the storage device, and to incorporate the normalized time availability data and standardized position coordinates into the prompt sentence as additional selection conditions.

3. The system according to claim 2, wherein the circuitry is configured to execute, in parallel with supplying the prompt sentence to the generative neural network model, a database search over the normalized time availability data and standardized position coordinates to identify candidate records whose availability and position fields mutually satisfy stored conditions, and to reconcile model-derived candidates and database-derived candidates by selecting candidates common to both as a reconciled candidate set.

4. The system according to claim 3, wherein the activity category data represents a type of competitive sport, the history record data represents past competition results, the performance data represents a skill level metric, and the attribute preference data specifies at least one of a capability condition, a regional condition, and a play-style condition for a desired opponent.

5. The system according to claim 4, wherein the circuitry is configured to receive, as part of the structured input data, venue information specifying a desired activity location, store the venue information in the storage device, and incorporate the venue information into the prompt sentence as a location constraint condition.

6. The system according to claim 1, wherein the circuitry is configured to construct the prompt sentence by encoding the structured input data as a labeled profile section, the participant attribute data as a labeled candidate section, and output format instructions as a labeled constraint section specifying that the generative neural network model is to return selection conditions in a machine-parseable format.

7. The system according to claim 6, wherein the circuitry is configured to parse the output of the generative neural network model to extract at least one of a query predicate, a filter condition, and a ranking criterion, and to construct the structured query using the extracted query predicate and filter condition.

8. The system according to claim 7, wherein the circuitry is configured to supply, in a second invocation, the candidate set and the encoded selection conditions to the generative neural network model to cause the generative neural network model to evaluate and rank the candidate records according to the selection conditions, and to receive explanatory text for each ranked candidate record from the generative neural network model.

9. The system according to claim 8, wherein the circuitry is configured to incorporate the explanatory text into the display data transmitted to the terminal device, the display data comprising, for each ranked candidate record, the compatibility score, the attribute information, the history record data, and the explanatory text.

10. The system according to claim 1, wherein the circuitry is configured to register or update the structured input data in the storage device using a query language, and to index the stored structured input data by the activity category data and the performance data to reduce query execution time for the structured query.

11. The system according to claim 10, wherein the circuitry is configured to receive, via the communication interface, updated history record data from the terminal device following completion of an activity session, update the stored structured input data in the storage device based on the updated history record data, and recompute compatibility scores for candidate records affected by the update.

12. The system according to claim 11, wherein the circuitry is configured to transmit updated display data to the terminal device reflecting the recomputed compatibility scores, and to update the index in the storage device based on the updated history record data.

13. The system according to claim 1, wherein the compatibility score is computed as a weighted combination of individual dimension scores, each individual dimension score reflecting a degree of correspondence between a field of the candidate record and a corresponding element of the attribute preference data, and wherein the circuitry is configured to determine weighting coefficients based on priority values extracted from the attribute preference data.

14. The system according to claim 13, wherein the circuitry is configured to receive feedback data from the terminal device indicating a user evaluation of one or more candidate records in the display data, update the weighting coefficients based on the feedback data, and recompute the compatibility scores using the updated weighting coefficients.

15. The system according to claim 14, wherein the circuitry is configured to store the updated weighting coefficients in the storage device in association with a user identifier, and to apply the updated weighting coefficients in subsequent structured queries executed on behalf of the user.

16. The system according to claim 1, wherein the circuitry is configured to generate a notification prompt sentence encoding a matched candidate record and transmit the notification prompt sentence to the generative neural network model to obtain notification message data, and to transmit the notification message data to a terminal device associated with the matched candidate record via the communication interface.

17. The system according to claim 16, wherein the matched candidate record corresponds to a user who has selected a competitive sport as the activity category data, and wherein the notification message data comprises schedule information derived from the time availability data of both the user and the matched candidate record.

18. A system comprising:
circuitry configured to:
receive, via a communication interface coupled to a packet-switched network, structured input data from a terminal device comprising activity category data, history record data, performance data, attribute preference data, time availability data, and position data, and store the structured input data in a storage device;
normalize the time availability data into a common time representation and convert the position data into standardized position coordinates, and update the stored structured input data in the storage device with the normalized values;
retrieve participant attribute data from the storage device corresponding to the activity category data, construct a prompt sentence encoding the structured input data and the participant attribute data as labeled sections with output format instructions, and supply the prompt sentence to a generative neural network model to obtain machine-usable selection conditions;
execute a structured query against the storage device using the machine-usable selection conditions and, in parallel, execute a database search using the normalized time availability data and standardized position coordinates, and reconcile results of the structured query and the database search to obtain a reconciled candidate set;
compute, for each candidate record in the reconciled candidate set, a compatibility score as a weighted combination of individual dimension scores reflecting correspondence between fields of the candidate record and the attribute preference data; and
rank the candidate records according to the compatibility scores, supply the ranked candidate records and the selection conditions to the generative neural network model in a second invocation to obtain explanatory text, generate display data comprising the compatibility scores, attribute information, and explanatory text for the ranked candidate records, and transmit the display data to the terminal device via the communication interface.

19. The system according to claim 18, wherein the circuitry is configured to receive feedback data from the terminal device indicating a user evaluation of one or more candidate records in the display data, update weighting coefficients used to compute the compatibility scores based on the feedback data, store the updated weighting coefficients in the storage device in association with a user identifier, and apply the updated weighting coefficients in subsequent structured queries.

20. A method comprising:
receiving, via a communication interface coupled to a packet-switched network, structured input data from a terminal device, and storing the structured input data in a storage device, the structured input data comprising activity category data, history record data, performance data, and attribute preference data associated with a user;
retrieving, from the storage device, participant attribute data corresponding to the activity category data, and generating a prompt sentence that encodes the structured input data and the participant attribute data as selection conditions for candidate identification;
supplying the prompt sentence to a generative neural network model and extracting, from output of the generative neural network model, machine-usable selection conditions for querying the storage device;
executing a structured query against the storage device using the machine-usable selection conditions to obtain a candidate set comprising a plurality of candidate records;
computing, for each candidate record in the candidate set, a compatibility score based on a multi-dimensional comparison between the performance data and the attribute preference data of the user and corresponding fields of the candidate record; and
ranking the candidate records according to the compatibility scores, generating display data comprising attribute information and history record data for the ranked candidate records, and transmitting the display data to the terminal device via the communication interface.
